(19) United States
(12) Patent Application Publication
(10) Pub. No.: US 2025/0320126 A1
(43) Pub. Date: Oct. 16, 2025

(54) GASEOUS ELEMENT/COMPOUND CAPTURE AND/OR CHEMICAL PRODUCTION UTILIZING REACTORS OR SET-UPS NEAR AMBIENT CONDITIONS

(71) Applicant: The Board of Trustees of the University of Illinois, Urbana, IL (US)

(72) Inventor: Chinmoy BAROI, Urbana, IL (US)

(73) Assignee: The Board of Trustees of the University of Illinois, Urbana, IL (US)

(21) Appl. No.: 18/977,015

(22) Filed: Dec. 11, 2024

Related U.S. Application Data
(60) Provisional application No. 63/609,081, filed on Dec. 12, 2023.

(51) Int. Cl. C01B 32/40; B01D 53/32; B01D 53/86; B01D 53/88; B01J 19/08; B01J 35/33; B01J 35/39; B01J 35/61; B01J 35/64

(52) U.S. Cl. CPC C01B 32/40; B01D 53/32; B01D 53/8671; B01D 53/885; B01J 19/088; B01J 35/33; B01J 35/39; B01J 35/612; B01J 35/613; B01J 35/615; B01J 35/617; B01J 35/618; B01J 35/643; B01J 35/647; B01J 35/651; B01D 2257/504; B01D 2258/06; B01D 2259/818; B01J 2219/0875; B01J 2219/0892; B01J 2219/0896

(57) ABSTRACT

Provided herein are apparatuses and methods of releasing or converting a gas. In some embodiments, an apparatus may include a gas flow cell having an inlet and an outlet for flowing a gas through said gas flow cell; a structured material within said gas flow cell, wherein the structured material has an electrical conductivity selected from the range of 3×10⁻¹⁵ S/m to 6.3×10⁷ S/m; and a plasma source integrated with said gas flow cell, the plasma source being configured to generate a plasma within a portion of the gas flow cell, the plasma source comprising: a first electrode and a second electrode within said gas flow cell; and a power source configured to provide voltage to the first and second electrodes.

### CROSS-REFERENCE TO RELATED APPLICATIONS

This application claims the benefit of priority to U.S. Provisional Patent Application No. 63/609,081 filed Dec. 12, 2023, which is hereby incorporated by reference in its entirety.

### STATEMENT REGARDING FEDERALLY SPONSORED RESEARCH OR DEVELOPMENT

Not applicable.

### BACKGROUND OF INVENTION

In the United States, electricity production accounted for 27.5% of the 2017 greenhouse gas emissions, of which the vast majority are carbon dioxide (CO₂; U.S. Energy Information Administration, 2020). Of these, coal combustion accounted for 67.9% of electricity-related CO₂ emissions (U.S. Environment Protection Agency, 2019). While coal-fueled power production in the future will be a smaller proportion of the energy mix, it, along with natural gas, are still expected to be significant CO₂ emitters. Therefore, it is imperative that the CO₂ footprint of power plants be reduced. Present CO₂ capture technologies are almost mature and focus on geological sequestration. However, sequestration is geologically constrained. The direct utilization of carbon dioxide is fairly limited. The conversion of CO₂ to carbon monoxide (CO) presents an opportunity for CO₂ utilization. For example, the CO₂ could be utilized to produce fuels and/or chemicals.

CO is an industrially important intermediate to produce bulk organic chemicals such as ethanol, 2,3-butanediol, and methyl ethyl ketone. At present, all these bulk chemicals are produced from fossil-based feedstock. The benefits of waste CO₂-derived CO utilization in producing these bulk chemicals provide two-fold benefits: (a) reduce dependence on the fossil feedstock, therefore, reducing the environmental footprint associated with the fossil feedstock processing; and (b) waste CO₂ valorization and net CO₂ emission reduction. The worldwide market for CO is expected to grow at a compound annual growth rate of roughly 5% over the next five years and will reach $4.6 billion (U.S.) in 2024 from $3.4 billion (U.S.) in 2019 (Industry Research Report, 2019). CO can be produced by the direct splitting of CO₂ (Snoeckx and Bogaerts, 2017). However, direct splitting is energy intensive due to the high heat of the reaction (DHo=+283 KJ/mol). CO₂ conversion to CO is easier when paired with a co-reactant such as methane (CH₄) or hydrogen (H₂). Commercially CO is produced from CO₂ through Boudouard Reaction above 800° C. Thus, the process is energy intensive. Alternatively, CO can be produced through reverse water gas shift reaction or dry reforming around and above 600° C. Thus, the conventional thermochemical CO production processes are energy intensive.

Solid sorbent materials-based CO₂ capture is gaining interest due to the waste generation associated with the solution-based capture solvents and water consumption during those solvents regeneration. However, the major drawback of sorbent-based adsorption technologies involves the energy intensive temperature/pressure/vacuum swing regeneration steps. More crucially, CO₂ conversion typically necessitates different elevated temperature and pressure combinations due to the molecule's stability against forming another product. Thus, it remains a challenge to develop a simultaneous capture and conversion system that operates under similar conditions, preferably ambient temperature and pressure. The CO production yield and plasma energy efficiency can be enhanced by using solid carbon-based catalysts. Plasma-based processes offer opportunities to operate in ambient temperature and pressure conditions. In previous plasma-based apparatuses, powder based sorbents/catalysts were used and separate electrodes were used to generate plasma. In this invention, the structured sorbent/catalyst acts as a plasma electrode itself and therefore makes the apparatus compact. This also makes the apparatus easily adaptable for the capture and/or conversion of various gases by interchanging the structured sorbent/catalyst.

### SUMMARY OF THE INVENTION

Provided herein are apparatuses and methods of releasing or converting a gas. In some embodiments, an apparatus may include a gas flow cell having an inlet and an outlet for flowing a gas through said gas flow cell; a structured material within said gas flow cell, wherein the structured material has an electrical conductivity selected from the range of 3×10⁻¹⁵ S/m to 6.3×10⁷ S/m; and a plasma source integrated with said gas flow cell, the plasma source being configured to generate a plasma within a portion of the gas flow cell, the plasma source comprising: a first electrode and a second electrode within said gas flow cell; and a power source configured to provide voltage to the first and second electrodes.

In some embodiments, a method of releasing or converting a gas may include flowing the gas through a gas flow cell having an inlet, an outlet, and a structured material provided within said gas flow cell, wherein the structured material has an electrical conductivity selected from the range of 3×10⁻¹⁵ S/m to 6.3×10⁷ S/m; and generating a plasma within a portion of the gas flow cell, wherein the plasma at least partially interacts with the gas and the structured material, thereby causing release of the gas and/or conversion of the gas.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Illustration of a unique reactor design to accommodate both resistive/joule heating and plasma along with structured catalysts.

FIG. 2: Image of the structured catalyst mediated transferred DC arc plasma reactor system illustrated in FIG. 1.

FIG. 3: Image of the structured catalyst mediated transferred DC arc plasma reactor system illustrated in FIG. 2 with ambient lighting turned off. This image highlights the position of the plasma created within the reactor.

FIG. 4: Close-up image of an electrode creating a plasma in the reactor system of FIGS. 2-3.

FIG. 5: More close-up image of the electrode imaged in FIG. 4.

FIG. 6: Image of supporting elements of the structured catalyst mediated transferred DC arc plasma reactor system of FIGS. 2-3.

FIGS. 7A-7B: FIG. 7A: Image of another unique reactor design to accommodate a plasma along with structured catalysts. FIG. 7B: Close-up image of an electrode creating a plasma in the reactor of FIG. 7A.

FIGS. 8A-8B: Illustrations of another unique reactor design to accommodate a plasma along with structured catalysts. Either a copper wire bunch (FIG. 8A) or a copper wire/rod (FIG. 8B) is used as an electrode.

FIGS. 9A-9D: Illustrations of another unique reactor design to accommodate a plasma along with structured catalysts using multiple copper wires/rods. The copper wires/rods on opposite sides of the structured catalysts may be aligned (FIGS. 9B, 9D) or unaligned (FIGS. 9A, 9C). The intermediate copper wires/rods may either be wired in series (FIGS. 9A-9B) or in alternating electrical polarity directions to the high voltage supply (FIGS. 9C-9D).

FIGS. 10A-10D: Illustrations of another unique reaction design to accommodate a plasma along with structured catalysts using multiple copper wires/rods. The copper wires/rods on opposite sides of the structured catalysts may be aligned (FIGS. 10B, 10D) or unaligned (FIGS. 10A, 10C). The intermediate copper wires/rods may either be wired in series (FIGS. 10A-10B) or in alternating electrical polarity directions to the high voltage supply (FIGS. 10C-10D). These designs also provide for joule/resistive heating of the structured catalyst.

### Statements Regarding Chemical Compounds and Nomenclature

In general, the terms and phrases used herein have their art-recognized meaning, which can be found by reference to standard texts, journal references and contexts known to those skilled in the art. The following definitions are provided to clarify their specific use in the context of the invention.

The term “gas flow cell” refers to a volume of space through which a gas may be flowed. In some examples, a gas flow cell may comprise an inlet and an outlet for flowing a gas through the gas flow cell. In some examples, a gas flow cell may be constructed from any suitable material, including, but not limited to, glass, plastic, or metal.

The term “structured material” refers to a material that has a structure. In some examples, a structured material may have a monolithic structure, a foam structure, or a corrugated sheet structure. In some examples, a structured material may have a periodic Open Cell Structure (POCS), for example, a Kelvin POCS, a cubic POCS, a diamond POCS, or a hybrid POCS.

The term “electrical conductivity” refers to a material's ability to conduct electric current. Electrical conductivity is commonly measured in S/m.

The term “plasma” refers to an ionized substance characterized by the presence of a significant portion of charged particles. In some examples, a plasma may be generated by applying an electric or magnetic field through a gas. In some examples, the charged particles may comprise ions and/or electrons. In some examples, the plasma is only partially ionized, due to the presence of neutral particles. In some examples, plasmas may demonstrate a high electrical conductivity.

The term “plasma source” refers to a power source electrically connected to two electrodes. The power source provides a voltage and current sufficient to produce a plasma through the gas between the electrodes. In some examples, the power source may be a direct current (DC) power source or an alternating current (AC) power source. In some examples, the plasma source may produce an arc plasma.

The term “power source” refers to a device capable of generating an electric current. In some examples, the power source may be a direct current (DC) power source or an alternating current (AC) power source. In some examples, the power source may be part of a plasma source. In some examples, the power source may be used to induce resistive/joule heating.

The term “sorbent material” refers to a material that absorbs and/or adsorbs liquids and/or gases. In some examples, a sorbent material may be a structured material. In some examples, the sorbent material may have a high affinity for certain materials, while lacking as high of an affinity for other materials. For example, a sorbent material may have a high affinity for carbon dioxide gas, nitrogen gas, hydrogen gas, methane, or ammonia gas.

The term “catalyst” refers to a material or substance that increases the rate of a chemical reaction. In some examples, a catalyst may increase the rate by providing an alternative reaction pathway with an activation energy lower than what is available without the catalyst. In some examples, a catalyst may be a heterogeneous catalyst (i.e., a catalyst that is in a different phase of matter than the reactants), or a homogenous catalyst (i.e., a catalyst that is in the same phase of matter as the reactants).

The term “photocatalyst” refers to a catalyst that increases the rate of a photochemical reaction. In some examples, a photocatalyst may absorb light and enter an excited state. The excited state of the photocatalyst may interact with the reactants, thereby forming reaction intermediates and regenerating itself after each interaction.

The term “porosity” refers to the ratio of empty space in a material to the total volume of the material. In some examples, more porous materials may have a greater surface area, and thus be more likely or able to chemically react.

The term “surface area” refers to the area of a material that is on the surface of a particle of said material. In some examples, materials with a larger surface area are more likely to react in a chemical reaction, or react more quickly in a chemical reaction.

The term “thermoelectric” refers to a material that creates a voltage when there is a temperature difference between a first side of the material and a second side of the material. In some examples, when a voltage is applied across a thermoelectric material, heat may be transferred from one side of the material to the other.

The term “piezoelectric” refers to a material that creates a voltage when mechanical stress is applied. In some examples, when a voltage is applied across a piezoelectric material, the material may be deformed.

The term “ferroelectric” refers to a material that exhibits spontaneous electric polarization. In some examples, the spontaneous electric polarization of a ferroelectric material may be reversed by a suitably strong applied electric field in the opposite direction. In some examples, a ferroelectric material may only be ferroelectric below a certain phase transition temperature.

The term “DC current plasma” refers to a plasma generated by applying a direct current (DC) through a gas. In some examples, the DC may be generated using a DC power source.

The term “AC current plasma” refers to a plasma generated by applying an alternating current (AC) through a gas. In some examples, the AC may include a radio frequency (RF) component.

The term “arc plasma” refers to a plasma generated by creating an electric arc between two electrodes. In some examples, such an arc can be initiated by ionization and glow discharge, when the current through the electrodes is increased. In some examples, such an arc can be initiated by two electrodes initially in contact and subsequently drawn apart. In some examples, an arc plasma may be formed using either a direct current (DC) or an alternating current (AC) power source. An arc plasma is different than a glow discharge plasma.

The term “dielectric material” refers to a material that acts as an electrical insulator. In some examples, the dielectric material may be polarized by an applied electric field.

The term “resistive/joule heating” refers to the process of heating an element via the heat generated by the passage of an electric current through a conductive material. In some examples, a structured material may be pre-treated using resistive/joule heating.

The term “pre-treat” refers to the preparation of a structured material for use in a chemical or physical reaction. In some examples, the pre-treatment may include heating the structured material, for example, using resistive/joule heating.

The term “metal foam” refers to a material or structure comprising a solid metal with gas-filled pores, wherein the gas-filled pores comprise a large portion of the volume. Optionally, the gas-filled pores may comprise at least 75%, at least 80%, at least 82.5%, at least 85%, at least 87.5% at least 90%, at least 92.5%, or at least 95% of the material.

The term “ceramic” refers to a material that is an inorganic, metallic oxide, nitride, or carbide material. Optionally, a ceramic material may comprise earthenware, porcelain, brick, or a similar material. Generally, ceramic materials are characterized as hard, brittle, heat-resistant, and corrosion-resistant.

The term “porous carbon” refers to a carbonaceous material comprising pores of various size. Optionally, the pores may comprise at least 75%, at least 80%, at least 82.5%, at least 85%, at least 87.5% at least 90%, at least 92.5%, or at least 95% of the material.

The term “carbon foam” refers to a material or structure comprising solid carbonaceous material with gas-filled pores, wherein the gas-filled pores comprise a large portion of the volume. Optionally, the gas-filled pores may comprise at least 75%, at least 80%, at least 82.5%, at least 85%, at least 87.5% at least 90%, at least 92.5%, or at least 95% of the material.

The term “polyaniline-based” refers to a material that is derived from a polyaniline coating, layer, surface, or material. In some embodiments, a polyaniline coating, layer, surface, or material may be polymerized, carbonized, and activated to produce a polyaniline-based porous carbon.

The term “hierarchical” refers to a material comprising structural elements which themselves have structure.

The term “n-doped carbon” refers to a carbon material wherein a portion of the carbon atoms are substituted by nitrogen atoms. The extent of the substitution can be described using atomic percent. For example, an n-doped carbon may comprise less than 25 at. %, less than 20 at. %, less than 15 at. %, less than 10 at. %, less than 9 at. %, less than 8 at. %, less than 7 at. %, less than 6 at. %, less than 5 at. %, less than 4 at. %, less than 3 at. %, less than 2 at. %, or less than 1 at. % nitrogen. Optionally, an n-doped carbon may comprise more than 0.01 at. %, more than 0.1 at. %, more than 0.25 at. %, more than 0.5 at. %, more than 0.75 at. %, more than 1 at. %, more than 2 at. %, more than 3 at. %, more than 4 at. %, more than 5 at. %, or more than 10 at. % nitrogen.

The term “average pore size” refers to the arithmetic mean of a parameter describing the size of the pores in a material. For example, average pore size may refer to the arithmetic mean of the diameter, the circumference, the radius, the thickness, the length, the depth, or another size parameter of the pores in a material.

The term “surface area” when referring to a structured material refers to the total area of the structured material that faces the exterior of the structured material. For some structured materials, the surface area includes surfaces within any pores or similar substructures.

The term “internal surface” when referring to a gas flow cell refers to a surface that is in contact with the flowed gas.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

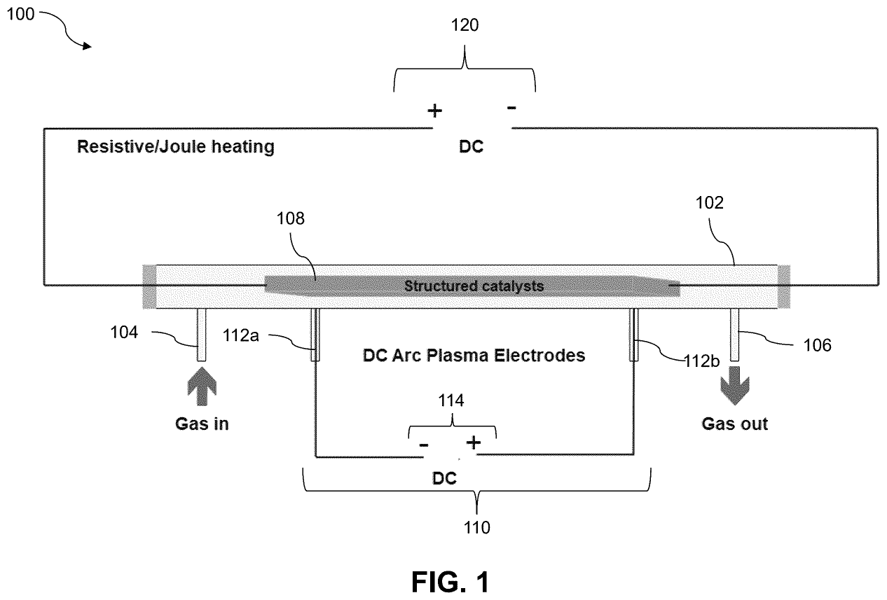

FIG. 1 is an illustration of an exemplary apparatus 100. Apparatus 100 comprises a gas flow cell 102 with an inlet 104 and an outlet 106. A structured material 108 comprising a structured catalyst is located within gas flow cell 102. A plasma source 110 is integrated with gas flow cell 102 and is configured to generate a DC arc plasma within a portion of gas flow cell 102. Plasma source 110 comprises electrodes 112a, 112b, within gas flow cell 102. Power source 114 is configured to provide a DC voltage to electrodes 112a, 112b. A resistive/joule heating source 120 is in thermal communication with structured material 108, and is configured to pre-treat structured material 108. In some embodiments, the flow rate of the gas through the flow cell may be at least 0.1 sccm, at least 0.5 sccm, at least 1 sccm, at least 5 sccm, at least 10 sccm, at least 15 sccm, or at least 20 sccm. In some embodiments, the flow rate of the gas through the flow cell may be at most 20 sccm, at most 15 sccm, at most 10 sccm, at most 5 sccm, at most 1 sccm, at most 0.5 sccm, or at most 0.1 sccm. Optionally, the flow rate of the gas may be selected from the range of 10 sccm to 20 sccm. In some embodiments, the pressure of the flow cell may be 1 atm. In some embodiments, the distance between the electrodes may be at least 0.5 in, at least 1 in, at least 1.5 in, at least 2 in, at least 2.5 in, at least 3 in, at least 3.5 in, at least 4 in, at least 4.5 in, at least 5 in, at least 5.5 in, or at least 6 in. In some embodiments, the distance between the electrodes may be at most 6 in, at most 5.5 in, at most 5 in, at most 4.5 in, at most 4 in, at most 3.5 in, at most 3 in, at most 2.5 in, at most 2 in, at most 1.5 in, at most 1 in, or at most 0.5 in. Optionally the distance between the electrodes may be selected from the range of 4 in to 6 in.

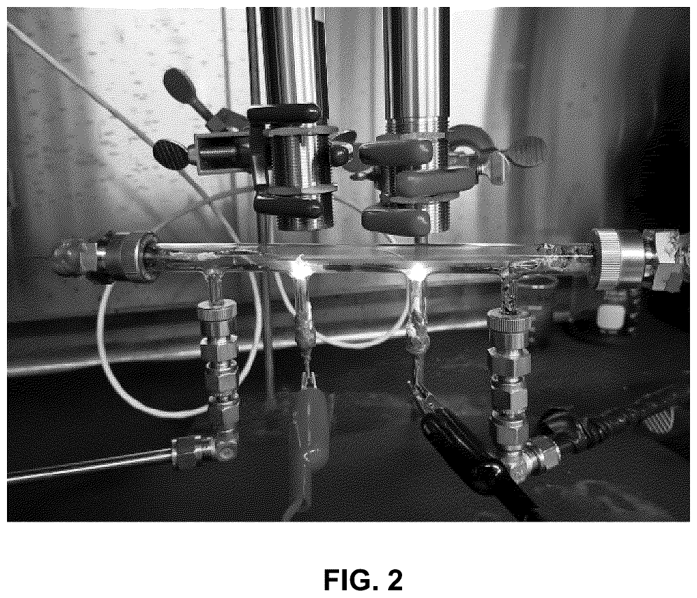

FIG. 2 is an image of the apparatus illustrated in FIG. 1. In the image, the gas flow cell can be seen with its inlet and outlet. The plasma formed by the plasma source can be seen as the two bright spots near the middle of the gas flow cell.

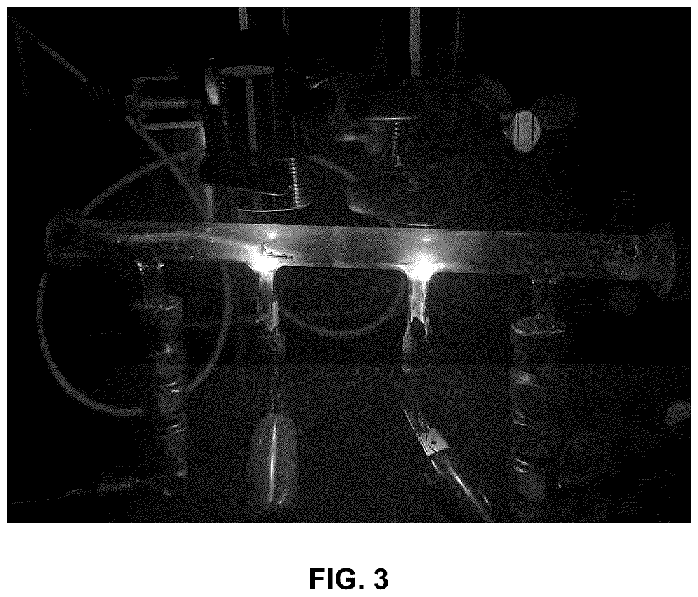

FIG. 3 is another image of the apparatus illustrated in FIG. 1. In this image, the ambient lighting is turned off. This highlights the position of the plasma. As can be seen in FIG. 3, the plasma not only exists near the electrodes, but throughout a portion of the gas flow cell.

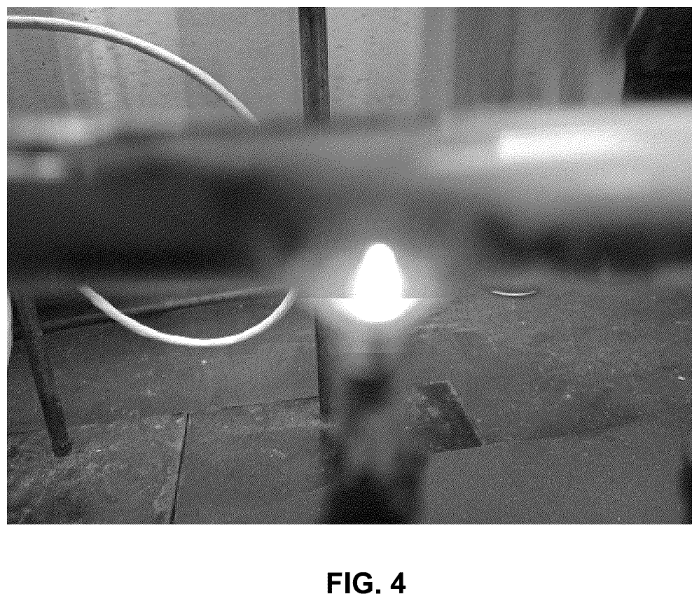

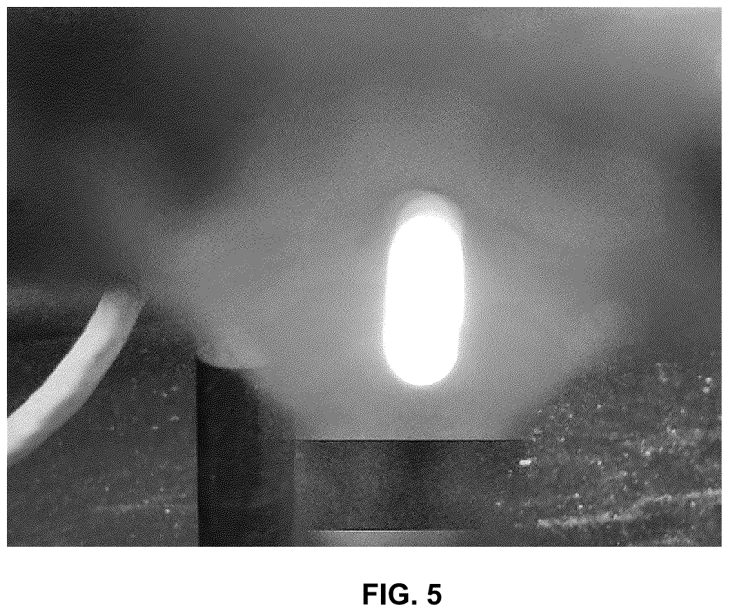

FIGS. 4 and 5 are close-up images of an electrode of the apparatus imaged in FIGS. 2-3, with the plasma being formed.

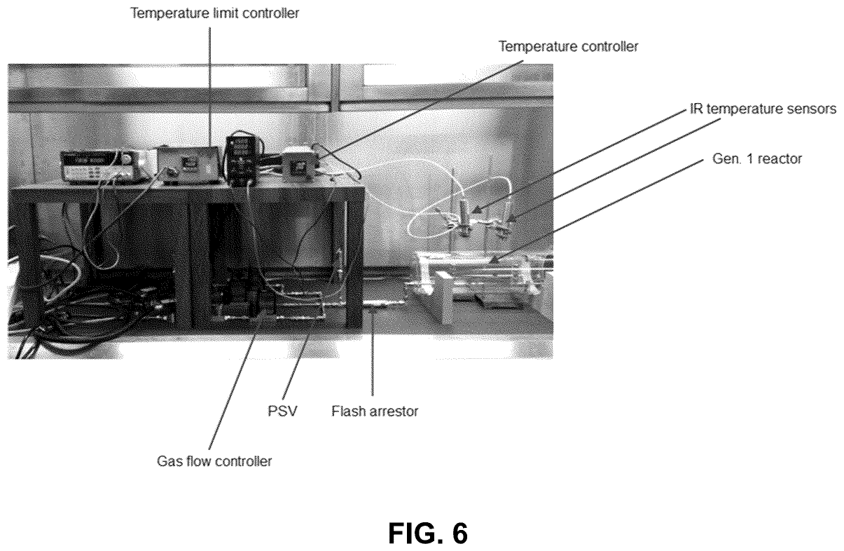

FIG. 6 is an image of supporting elements of the apparatus imaged in FIGS. 2-5. In the image is shown a temperature limit controller, a temperature controller, a gas flow controller, a PSV, a flash arrestor, IR temperature sensors, and the apparatus. The temperature limit controller shuts down the gas flows and cut off the power of plasma and heating (if necessary in the main process and/or preheating) in case of overshoot of the desired temperature. The temperature controller controls the power for the resistive/joule heating (if necessary in the main process and/or preheating). The gas flow controller is configured to control the gas flow of the reagent gas within the gas flow cell. The PSV is configured to protect the flow cell and the flow line against pressure build up. The flash arrestor is configured to protect the flow line, the flow controllers, gas cylinders reaching out any accidental fire from the flow cell. The IR temperature sensors are configured to sense the temperature of the plasma.

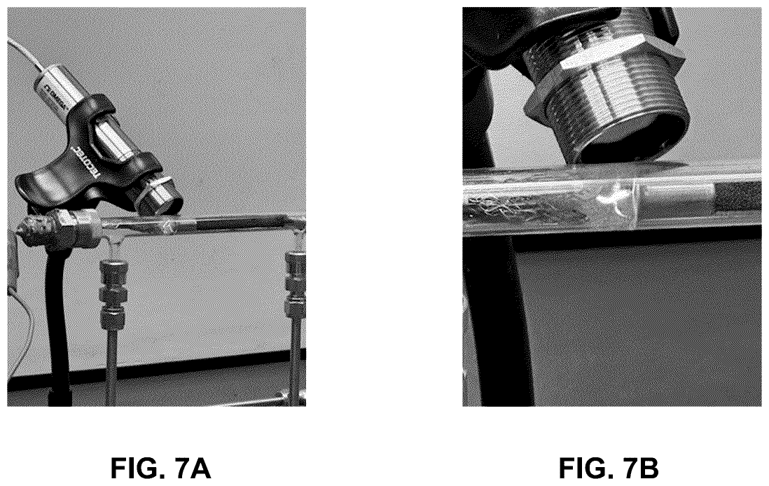

FIGS. 7A-7B are close-up images of an exemplary apparatus 200, with the plasma being formed.

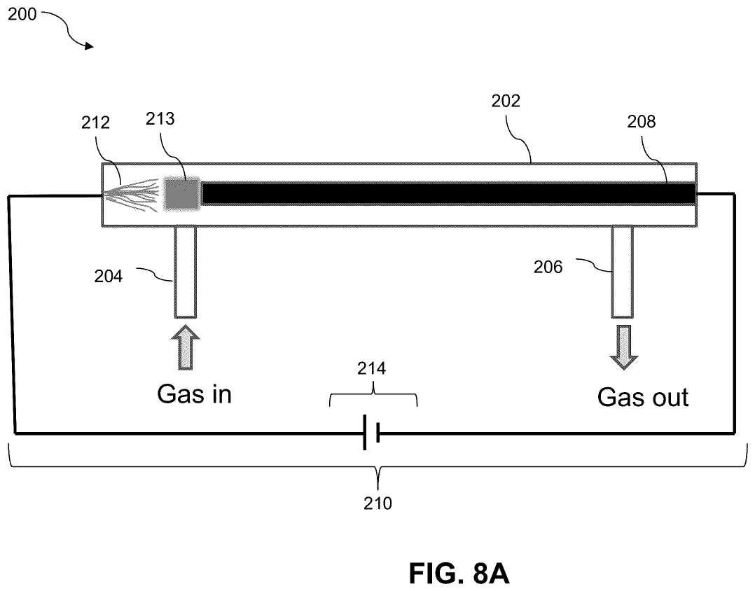

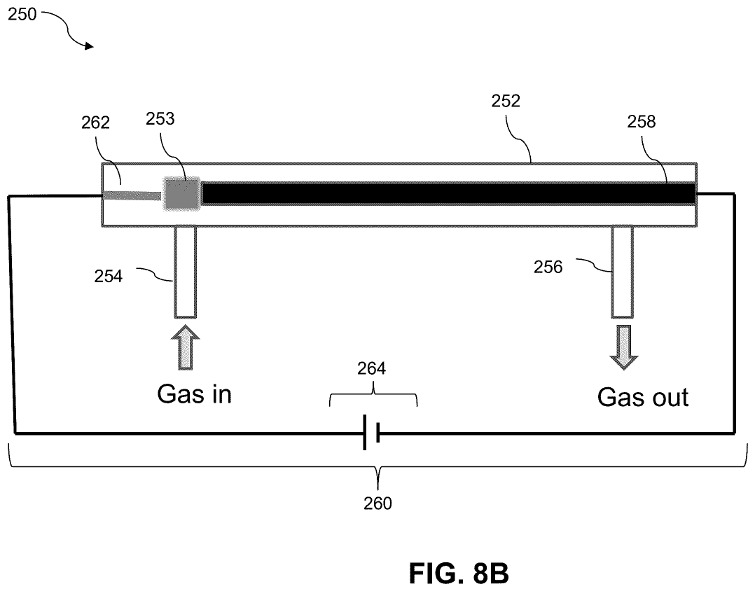

FIG. 8A is an illustration of another exemplary apparatus 200. Apparatus 200 comprises a gas flow cell 202 with an inlet 204 and an outlet 206. A structured material 208 comprising a structured catalyst is located within gas flow cell 202. A plasma source 210 is integrated with gas flow cell 202 and is configured to generate a DC arc plasma 214 within a portion of gas flow cell 202. Plasma source 210 comprises electrode 212 within gas flow cell 202. In some embodiments, electrode 212 comprises a copper wire bunch. In some embodiments, each of the copper wires in the copper wire bunch independently has a thickness of at least 0.25 mm, at least 0.5 mm, at least 0.75 mm, or at least 1 mm. In some embodiments, each of the copper wires in the copper wire bunch independently has a thickness of at most 1 mm, at most 0.75 mm, at most 0.5 mm, or at most 0.25 mm. Optionally, the thickness of each of the copper wires in the copper wire bunch may be independently selected from the range of 0.5 mm to 1 mm. In some embodiments, the copper wire bunch may comprise at least 5, at least 10, at least 15, at least 20, at least 25, or at least 30 copper wires. In some embodiments, the copper wire bunch may comprise at most 30, at most 25, at most 20, at most 15, at most 10, or at most 5 copper wires. Optionally, the number of copper wires comprising the copper wire bunch may be selected from the range of 10 to 30 copper wires. Power source 214 is configured to provide a DC voltage to electrode 212 and structured material 208.

In some embodiments, a resistive/joule heating source (not shown) may be in thermal communication with structured material 208, and be configured to pre-treat structured material 208. For example, electrode 212 may be in electrical communication with structured material 208.

FIG. 8B is an illustration of another exemplary apparatus 250. Apparatus 250 comprises a gas flow cell 252 with an inlet 254 and an outlet 256. A structured material 258 comprising a structured catalyst is located within gas flow cell 252. A plasma source 260 is integrated with gas flow cell 252 and is configured to generate a DC arc plasma 253 within a portion of gas flow cell 252. Plasma source 260 comprises electrode 262 within gas flow cell 252. In some embodiments, electrode 262 comprises a copper wire/rod. Power source 264 is configured to provide a DC voltage to electrode 262 and structured material 258.

In some embodiments, a resistive/joule heating source (not shown) may be in thermal communication with structured material 258, and be configured to pre-treat structured material 258. For example, electrode 212 may be in electrical communication with structured material 208.

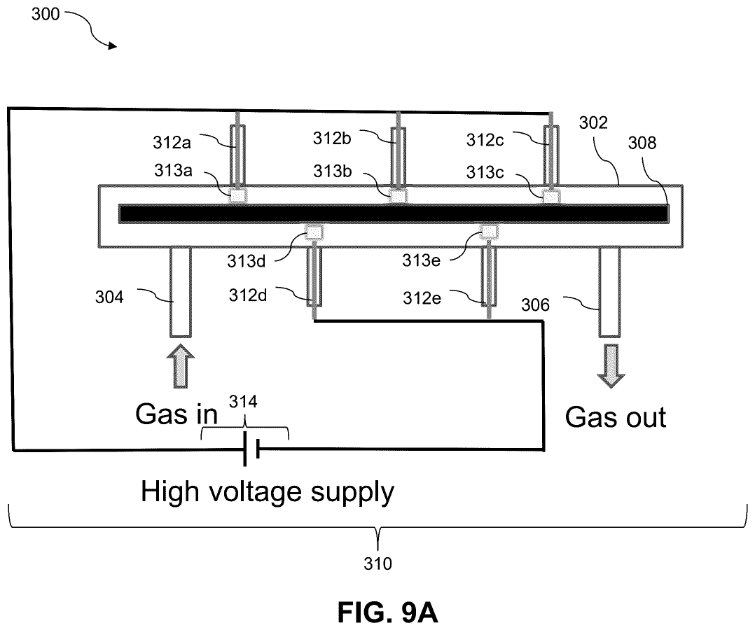

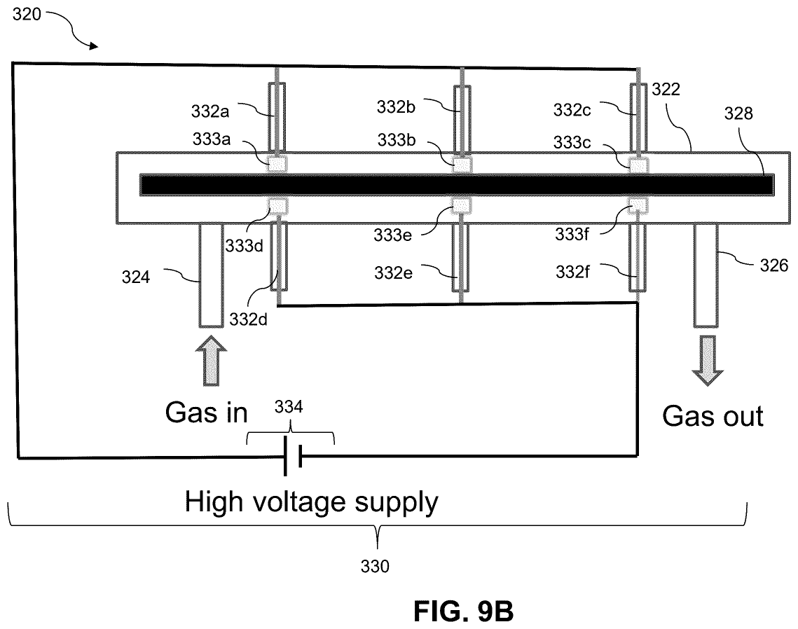

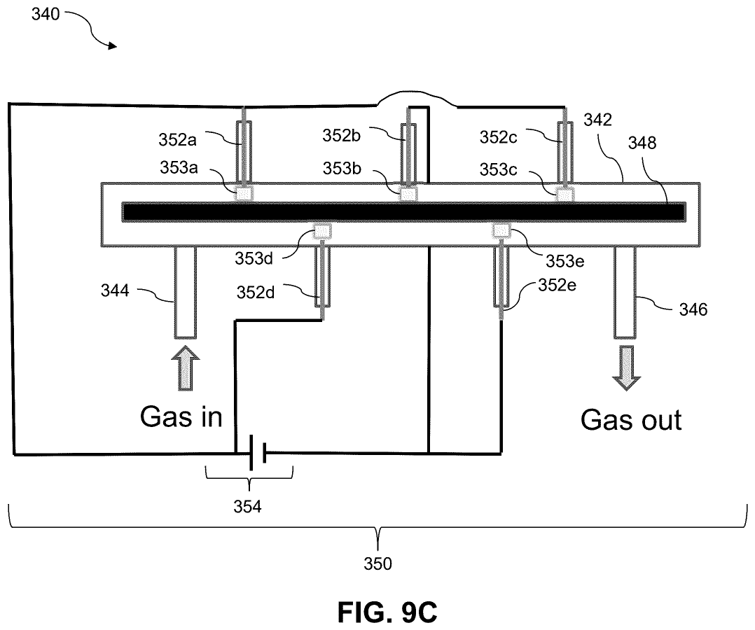

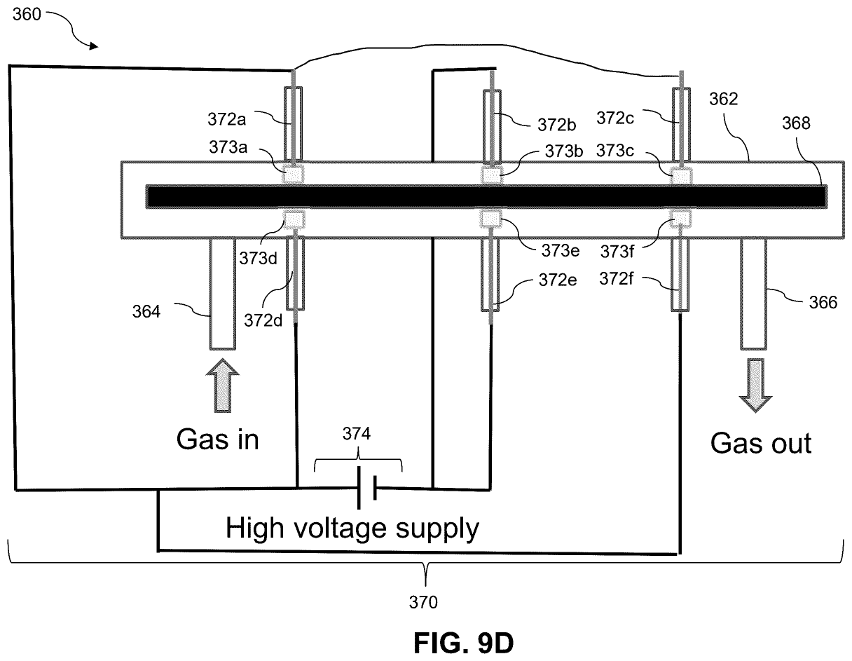

FIG. 9A is an illustration of another exemplary apparatus 300. Apparatus 300 comprises a gas flow cell 302 with an inlet 304 and an outlet 306. A structured material 308 comprising a structured catalyst is located within gas flow cell 302. A plasma source 310 is integrated with gas flow cell 302 and is configured to generate DC arc plasmas 313a, 313b, 313c, 313d, 313e within a portion of gas flow cell 302. Plasma source 310 comprises electrodes 312a, 312b, 312c, 312d, 312e within gas flow cell 302. Power source 314 is configured to provide a DC voltage to electrodes 312a, 312b, 312c, 312d, 312e.

In some embodiments, electrodes 312a, 312b, 312c, 312d, 312e each comprise a copper wire/rod. In some embodiments, electrodes 312a, 312b, and 312c are located on a distal side of gas flow cell 302. In some embodiments, electrodes 312d and 312e are located on a proximal side of gas flow cell 302.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 302 between electrodes 312a and 312c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 302 between electrodes 312d and 312e. In these embodiments, each additional electrode is configured to generate an additional plasma.

In some embodiments, each electrode (e.g., 312a, 312b, 312c) located on the distal side of gas flow cell 302 are in electric communication with a first side of power source 314. In some embodiments, each electrode (e.g., 312d, 312e) located on the proximal side of gas flow cell 302 are in electric communication with a second side of power source 314. Each additional electrode pair creates an additional plasma. Therefore, generally, the efficiency of gas release and conversion increases with the number of electrode pairs included.

In some embodiments, each electrode (e.g., 312a, 312b, 312c) located on the distal side of gas flow cell 302 is not directly across gas flow cell 302 from an electrode (e.g., 312d, 312e) located on the proximal side of gas flow cell 302. The non-alignment of the electrodes 312 in this fashion provides a maximum amount of electricity passing through structured material 308.

FIG. 9B is an illustration of another exemplary apparatus 320. Apparatus 320 comprises a gas flow cell 322 with an inlet 324 and an outlet 326. A structured material 328 comprising a structured catalyst is located within gas flow cell 322. A plasma source 330 is integrated with gas flow cell 322 and is configured to generate a DC arc plasmas 333a, 333b, 333c, 333d, 333e within a portion of gas flow cell 322. Plasma source 330 comprises electrodes 332a, 332b, 332c, 332d, 332e, 332f within gas flow cell 322. Power source 334 is configured to provide a DC voltage to electrodes 332a, 332b, 332c, 332d, 332e, 332f.

In some embodiments, electrodes 332a, 332b, 332c, 332d, 332e, 332f each comprise a copper wire/rod. In some embodiments, electrodes 332a, 332b, and 332c are located on a distal side of gas flow cell 322. In some embodiments, electrodes 332d, 332e, and 332f are located on a proximal side of gas flow cell 322.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 322 between electrodes 332a and 332c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 322 between electrodes 332d and 332f. In these embodiments, each additional electrode is configured to generate an additional plasma.

In some embodiments, each electrode (e.g., 332a, 332b, 332c) located on the distal side of gas flow cell 322 are in electric communication with a first side of power source 334. In some embodiments, each electrode (e.g., 332d, 332e, 332f) located on the proximal side of gas flow cell 322 are in electric communication with a second side of power source 334. This configuration provides ease of manufacturing.

In some embodiments, each electrode (e.g., 332a, 332b, 332c) located on the distal side of gas flow cell 322 is directly across gas flow cell 322 from an electrode (e.g., 332d, 332e, 332f) located on the proximal side of gas flow cell 322. This configuration provides ease of manufacturing.

FIG. 9C is an illustration of another exemplary apparatus 340. Apparatus 340 comprises a gas flow cell 342 with an inlet 344 and an outlet 346. A structured material 348 comprising a structured catalyst is located within gas flow cell 342. A plasma source 350 is integrated with gas flow cell 342 and is configured to generate a DC arc plasmas 353a, 353b, 353c, 353d, 353e within a portion of gas flow cell 302. Plasma source 350 comprises electrodes 352a, 352b, 352c, 352d, 352e within gas flow cell 342. Power source 354 is configured to provide a DC voltage to electrodes 352a, 352b, 352c, 352d, 352e. In some embodiments, the DC voltage may be at least 1 V, at least 1.5 V, at least 2 V, at least 2.5 V, at least 3 V, at least 3.5 V, at least 4 V, at least 4.5 V, at least 5 V, at least 5.5 V, at least 6 V, at least 6.5 V, at least 7 V, at least 7.5 V, at least 8 V, at least 8.5 V, at least 9 V, at least 9.5 V, at least 10 V, at least 10.5 V, at least 11 V, at least 11.5 V, or at least 12 V. In some embodiments, the DC voltage may be at most 12 V, at most 11.5 V, at most 11 V, at most 10.5 V, at most 10 V, at most 9.5 V, at most 9 V, at most 8.5 V, at most 8 V, at most 7.5 V, at most 7 V, at most 6.5 V, at most 6 V, at most 5.5 V, at most 5 V, at most 4.5 V, at most 4 V, at most 3.5 V, at most 3 V, at most 2.5 V, at most 2 V, at most 1.5 V, or at most 1 V. Optionally, the DC voltage may be selected from the range of 1.5 V to 12 V. In some embodiments, the current provided by power source 354 to the electrodes may be at least 0.1 A, 0.2 A, 0.3 A, 0.4 A, 0.5 A, 1 A, 1.5 A, 2 A, 2.5 A, 3 A, 3.5 A, or 4 A. In some embodiments, the current provided by power source 354 to the electrodes may be at most 4 A, 3.5 A, 3 A, 2.5 A, 2 A, 1.5 A, 1 A, 0.5 A, 0.4 A, 0.3 A, 0.2 A, or 0.1 A. Optionally the current may be selected from the range of 0.1 A to 4 A.

In some embodiments, electrodes 352a, 352b, 352c, 352d, 352e each comprise a copper wire/rod. In some embodiments, electrodes 352a, 352b, and 352c are located on a distal side of gas flow cell 342. In some embodiments, electrodes 352d and 352e are located on a proximal side of gas flow cell 342.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 342 between electrodes 352a and 352c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 342 between electrodes 352d and 352e. In these embodiments, each additional electrode is configured to generate an additional plasma.

In some embodiments, only a portion of the electrodes, including electrodes 352a, 352c, and 352d are in electric communication with a first side of power source 354. In some embodiments, the remaining electrodes, including electrode 352e, are in electric communication with a second side of power source 354.

FIG. 9D is an illustration of another exemplary apparatus 360. Apparatus 360 comprises a gas flow cell 362 with an inlet 364 and an outlet 366. A structured material 368 comprising a structured catalyst is located within gas flow cell 362. A plasma source 370 is integrated with gas flow cell 362 and is configured to generate a DC arc plasmas 373a, 373b, 373c, 373d, 373e within a portion of gas flow cell 362. Plasma source 370 comprises electrodes 372a, 372b, 372c, 372d, 372e, 372f within gas flow cell 362. Power source 374 is configured to provide a DC voltage to electrodes 372a, 372b, 372c, 372d, 372e, 372f.

In some embodiments, electrodes 372a, 372b, 372c, 372d, 372e, 372f each comprise a copper wire/rod. In some embodiments, electrodes 372a, 372b, and 372c are located on a distal side of gas flow cell 362. In some embodiments, electrode 372d, 372e, and 372f are located on a proximal side of gas flow cell 362.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 342 between electrodes 372a and 372c. In these embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 362 between electrodes 372d and 372f. In these embodiments, each additional electrode is configured to generate an additional plasma.

In some embodiments, only a portion of the electrodes, including electrodes 372a, 372c, 372d, and 372f are in electric communication with a first side of power source 374. In some embodiments, the remaining electrodes, including electrodes 372b and 372e, are in electric communication with a second side of power source 374. Having the electrodes 372 in an unaligned configuration, such as in these embodiments, maximizes the amount of electricity that passes through structured material 368.

In some embodiments, a resistive/joule heating source (not shown) may be in thermal communication with structured material 368, and be configured to pre-treat structured material 368.

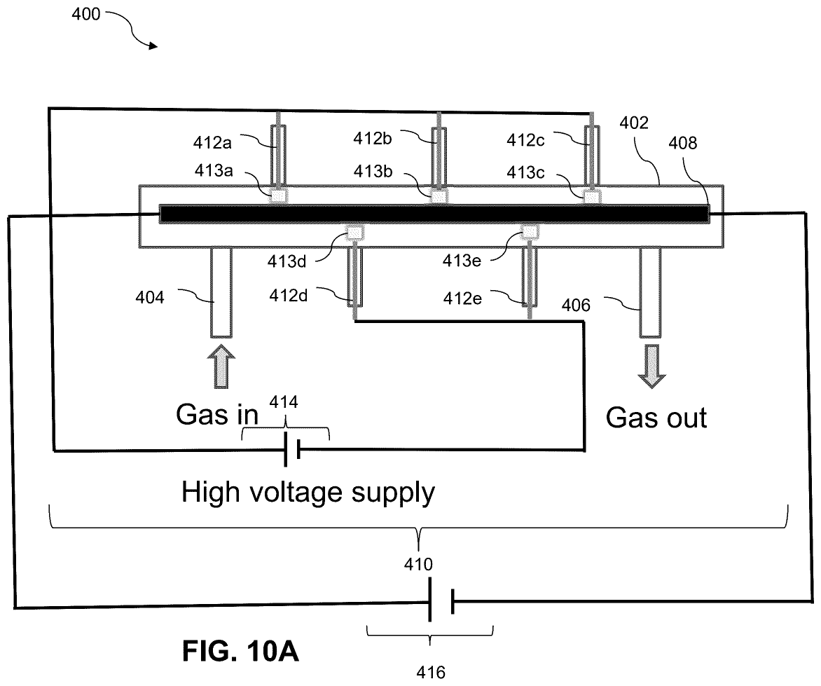

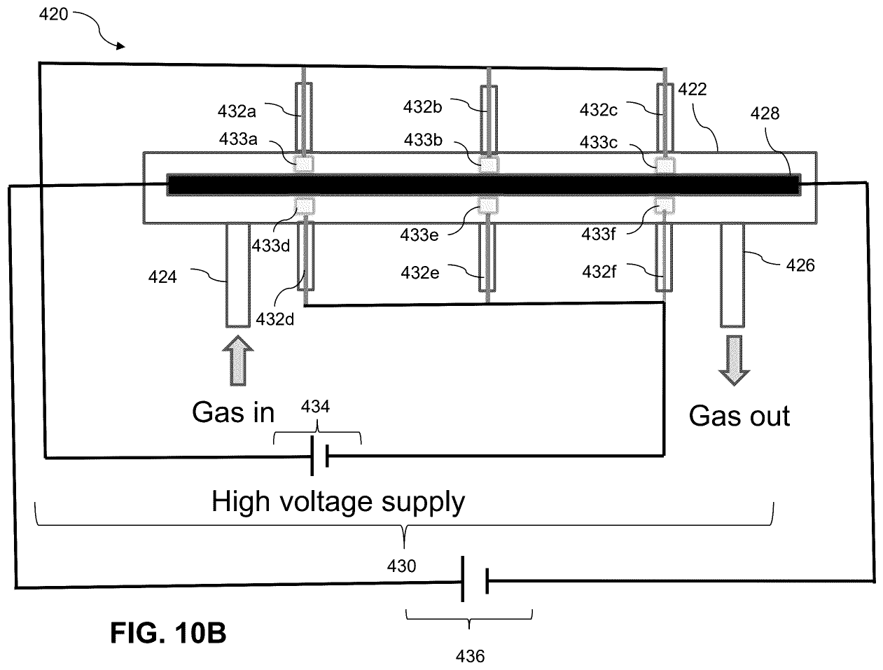

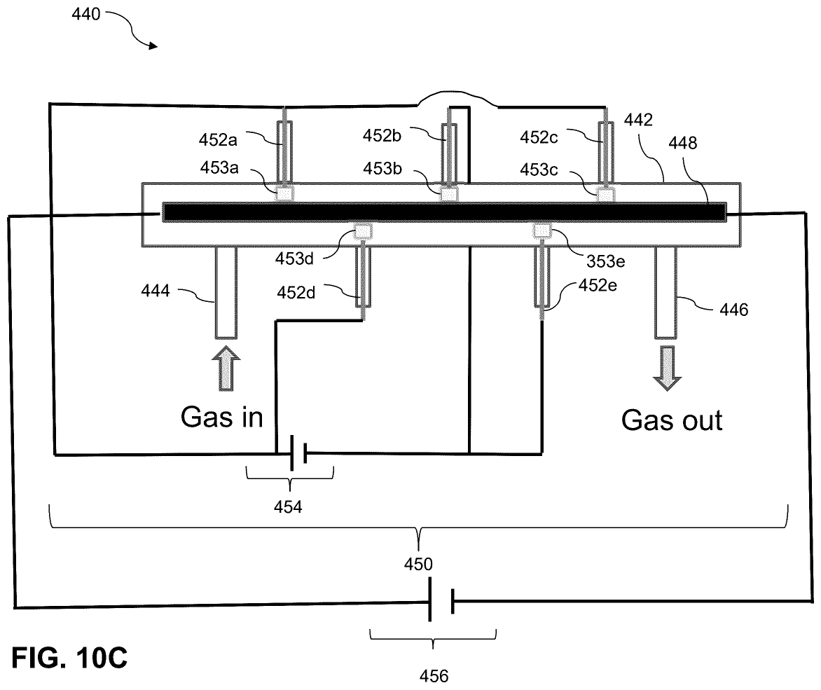

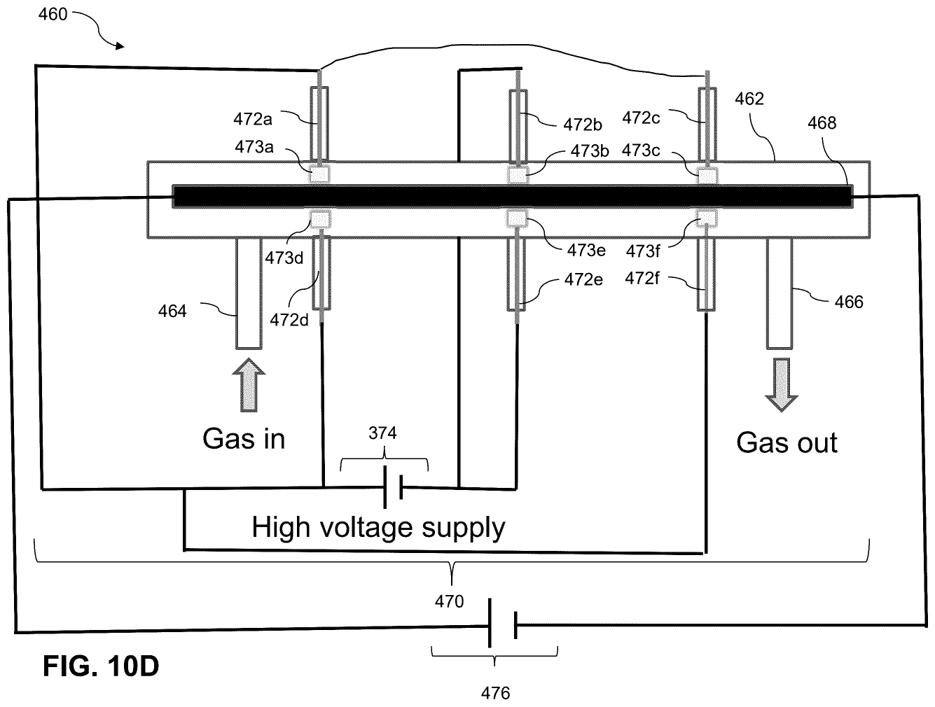

FIG. 10A is an illustration of another exemplary apparatus 400. Apparatus 400 comprises a gas flow cell 402 with an inlet 404 and an outlet 406. A structured material 408 comprising a structured catalyst is located within gas flow cell 402. A plasma source 410 is integrated with gas flow cell 402 and is configured to generate a DC arc plasmas 413a, 413b, 413c, 413d, 413e within a portion of gas flow cell 402. Plasma source 410 comprises electrodes 412a, 412b, 412c, 412d, 412e within gas flow cell 402. Power source 414 is configured to provide a DC voltage to electrodes 412a, 412b, 412c, 412d, 412e.

In some embodiments, electrodes 412a, 412b, 412c, 412d, 412e each comprise a copper wire/rod. In some embodiments, electrodes 412a, 412b, and 412c are located on a distal side of gas flow cell 402. In some embodiments, electrodes 412d and 412e are located on a proximal side of gas flow cell 402.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 402 between electrodes 412a and 412c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 402 between electrodes 412d and 412e. In these embodiments, each additional electrode is configured to generate an additional plasma.

In some embodiments, each electrode (e.g., 412a, 412b, 412c) located on the distal side of gas flow cell 402 are in electric communication with a first side of power source 414. In some embodiments, each electrode (e.g., 412d, 412e) located on the proximal side of gas flow cell 402 are in electric communication with a second side of power source 414. Each additional electrode pair creates an additional plasma. Therefore, generally, the efficiency of gas release and conversion increases with the number of electrode pairs included.

In some embodiments, each electrode (e.g., 412a, 412b, 412c) located on the distal side of gas flow cell 402 is not directly across gas flow cell 402 from an electrode (e.g., 412d, 412e) located on the proximal side of gas flow cell 402. The staggering or misalignment of the electrodes 412 in this fashion provides a maximum amount of electricity passing through structured material 408.

In some embodiments, a resistive/joule heating source 416 is in thermal communication with structured material 408, and is configured to pre-treat structured material 408.

FIG. 10B is an illustration of another exemplary apparatus 420. Apparatus 420 comprises a gas flow cell 422 with an inlet 424 and an outlet 426. A structured material 428 comprising a structured catalyst is located within gas flow cell 422. A plasma source 430 is integrated with gas flow cell 422 and is configured to generate a DC arc plasmas 433a, 433b, 433c, 433d, 433e within a portion of gas flow cell 422. Plasma source 430 comprises electrodes 432a, 432b, 432c, 432d, 432e, 432f within gas flow cell 422. Power source 434 is configured to provide a DC voltage to electrodes 432a, 432b, 432c, 432d, 432e, 432f.

In some embodiments, electrodes 432a, 432b, 432c, 432d, 432e, 432f each comprise a copper wire/rod. In some embodiments, electrodes 432a, 432b, and 432c are located on a distal side of gas flow cell 422. In some embodiments, electrodes 432d, 432e, and 432f are located on a proximal side of gas flow cell 422.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 422 between electrodes 432a and 432c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 422 between electrodes 432d and 432f. In these embodiments, each additional electrode is configured to generate an additional plasma.

In some embodiments, each electrode (e.g., 432a, 432b, 432c) located on the distal side of gas flow cell 422 are in electric communication with a first side of power source 434. In some embodiments, each electrode (e.g., 432d, 432e, 432f) located on the proximal side of gas flow cell 422 are in electric communication with a second side of power source 434. This configuration provides ease of manufacturing.

In some embodiments, each electrode (e.g., 432a, 432b, 432c) located on the distal side of gas flow cell 422 is directly across gas flow cell 422 from an electrode (e.g., 432d, 432e, 432f) located on the proximal side of gas flow cell 422. This configuration provides ease of manufacturing.

In some embodiments, a resistive/joule heating source 436 may be in thermal communication with structured material 428, and be configured to pre-treat structured material 428.

FIG. 10C is an illustration of another exemplary apparatus 440. Apparatus 440 comprises a gas flow cell 442 with an inlet 444 and an outlet 446. A structured material 448 comprising a structured catalyst is located within gas flow cell 442. A plasma source 450 is integrated with gas flow cell 442 and is configured to generate a DC arc plasmas 453a, 453b, 453c, 453d, 453e within a portion of gas flow cell 442. Plasma source 450 comprises electrodes 452a, 452b, 452c, 452d, 452e within gas flow cell 442. Power source 454 is configured to provide a DC voltage to electrodes 452a, 452b, 452c, 452d, 452e. In some embodiments, the DC voltage may be at least 1 V, at least 1.5 V, at least 2 V, at least 2.5 V, at least 3 V, at least 3.5 V, at least 4 V, at least 4.5 V, at least 5 V, at least 5.5 V, at least 6 V, at least 6.5 V, at least 7 V, at least 7.5 V, at least 8 V, at least 8.5 V, at least 9 V, at least 9.5 V, at least 10 V, at least 10.5 V, at least 11 V, at least 11.5 V, or at least 12 V. In some embodiments, the DC voltage may be at most 12 V, at most 11.5 V, at most 11 V, at most 10.5 V, at most 10 V, at most 9.5 V, at most 9 V, at most 8.5 V, at most 8 V, at most 7.5 V, at most 7 V, at most 6.5 V, at most 6 V, at most 5.5 V, at most 5 V, at most 4.5 V, at most 4 V, at most 3.5 V, at most 3 V, at most 2.5 V, at most 2 V, at most 1.5 V, or at most 1 V. Optionally, the DC voltage may be selected from the range of 1.5 V to 12 V. In some embodiments, the current provided by power source 454 to the electrodes may be at least 0.1 A, 0.2 A, 0.3 A, 0.4 A, 0.5 A, 1 A, 1.5 A, 2 A, 2.5 A, 3 A, 3.5 A, or 4 A. In some embodiments, the current provided by power source 454 to the electrodes may be at most 4 A, 3.5 A, 3 A, 2.5 A, 2 A, 1.5 A, 1 A, 0.5 A, 0.4 A, 0.3 A, 0.2 A, or 0.1 A. Optionally the current may be selected from the range of 0.1 A to 4 A.

In some embodiments, electrodes 452a, 452b, 452c, 452d, 452e each comprise a copper wire/rod. In some embodiments, electrodes 452a, 452b, and 452c are located on a distal side of gas flow cell 442. In some embodiments, electrodes 452d and 452e are located on a proximal side of gas flow cell 442.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 442 between electrodes 452a and 452c. In such embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 442 between electrodes 452d and 452e. In these embodiments, each additional electrode is configured to generate an additional plasma.

In some embodiments, only a portion of the electrodes, including electrodes 452a, 452c, and 452d are in electric communication with a first side of power source 454. In some embodiments, the remaining electrodes, including electrode 452e, are in electric communication with a second side of power source 454.

In some embodiments, a resistive/joule heating source 456 may be in thermal communication with structured material 448, and be configured to pre-treat structured material 448.

FIG. 10D is an illustration of another exemplary apparatus 460. Apparatus 460 comprises a gas flow cell 462 with an inlet 464 and an outlet 466. A structured material 468 comprising a structured catalyst is located within gas flow cell 462. A plasma source 470 is integrated with gas flow cell 462 and is configured to generate DC arc plasmas 473a, 473b, 473c, 473d, 473e within a portion of gas flow cell 462. Plasma source 470 comprises electrodes 472a, 472b, 472c, 472d, 472e, 472f within gas flow cell 462. Power source 474 is configured to provide a DC voltage to electrodes 472a, 472b, 472c, 472d, 472e, 472f.

In some embodiments, electrodes 472a, 472b, 472c, 472d, 472e, 472f each comprise a copper wire/rod. In some embodiments, electrodes 472a, 472b, and 472c are located on a distal side of gas flow cell 462. In some embodiments, electrode 472d, 472e, and 472f are located on a proximal side of gas flow cell 462.

In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the distal side of gas flow cell 442 between electrodes 472a and 472c. In these embodiments, each additional electrode is configured to generate an additional plasma. In some embodiments, there may be additional electrodes (e.g., optionally 1, 2, 3, 4, 5, 6, 7, 8, 9, 10, 15, 20, 25, 30, 35, 40, 45, 50, 100, or more additional electrodes) located on the proximal side of gas flow cell 462 between electrodes 472d and 472f. In these embodiments, each additional electrode is configured to generate an additional plasma.

In some embodiments, only a portion of the electrodes, including electrodes 472a, 472c, 472d, and 472f are in electric communication with a first side of power source 474. In some embodiments, the remaining electrodes, including electrodes 472b and 472e, are in electric communication with a second side of power source 474. Having the electrodes 472 in an unaligned configuration, such as in these embodiments, maximizes the amount of electricity that passes through structured material 468.

In some embodiments, a resistive/joule heating source 476 may be in thermal communication with structured material 468, and be configured to pre-treat structured material 468.

In some embodiments, the apparatus generates CO, CH₄, an alcohol (e.g., CH₃OH, CH₃CH₂OH), an organic acid, a hydrocarbon, an aldehyde (e.g., formaldehyde, acetaldehyde), an alkane (e.g., methane), an alkene (e.g., ethylene, propylene), or a combination thereof. In some embodiments, the conversion of CO₂ generates CO, CH₄, CH₃OH, CH₃CH₂OH, an organic acid, a hydrocarbon, an aldehyde, formaldehyde, acetaldehyde, or a combination thereof.

In some embodiments, the apparatus is configured for alkane (e.g., CH₄, C₂H₆, C₃H₈, C₄H₁₀) conversion, including the conversion of ethane and propane. In some embodiments, the conversion of an alkane generates an alkene (e.g., C₂H₂, C₂H₄, C₃H₆, C₄H₈), including the generation of ethylene and propylene.

The invention can be further understood by the following non-limiting examples.

### Example 1

Carbon Dioxide (CO₂) to Value Added Products Production (CO₂ Utilization) Near Room Temperature Using Plasma in Presence of Catalysts/Structured Catalysts

Energy consumption and harsh reaction conditions are barriers for large-scale chemicals production economically and with a minimal environmental impact (low greenhouse gas (GHG) emission). This disclosure deals with inventions mitigating these problems by developing reactors or set-ups (catalytic or non-catalytic reactors or set-ups) near ambient conditions to produce various chemicals following various chemical reaction routes.

The invention provides a unique reactor design to accommodate both resistive/joule heating and an arc plasma along with structured catalysts. The plasma is generated by a high-voltage generator or transformer.

The invention provides structured catalysts responsive to arc plasma for CO₂ conversion. The structured catalysts consist of porous foam structure (i.e., metal foam, ceramic, SiC) or metallic alloy mesh covered with a layer of single or multiple thermoelectric and/or piezoelectric and/or ferroelectric material powders and coated catalysts on the top of it. The catalysts can be conductive/magnetic/semi-conductive and/or combination of multiple properties in nature.

The invention provides CO production from CO₂ at atmospheric pressure and near room temperature (40-65° C.).

### Preliminary Results

| | CO₂ | CO |
|---|---|---|
| | conversion | selectivity |
| Reaction | % | % |
| Direct CO₂ splitting | 13.6 | 100 |
| Reverse water gas shift reaction | 43.4 | 95 |

### References for Example 1

[1] Industry Research. Feb. 21, 2019. Global carbon monoxide market 2019 by manufacturers, regions, type and application, forecast to 2024.

https://www.industryresearch.biz/global-carbon-monoxide-market-13875684 (accessed 26 Sep. 2021).
[2] Snoeckx, R., and A. Bogaerts. 2017. Plasma technology-a novel solution for CO₂ conversion? Chemical Society Reviews, 48:5805-5863.
[3] U.S. Environment Protection Agency. 2019. Inventory of U.S. Greenhouse Gas Emissions and Sinks. EPA 430-R-19-001.
[4] U.S. Energy Information Administration. 2020. U.S. Energy-Related Carbon Dioxide Emissions, 2019. https://www.eia.gov/environment/emissions/carbon/(accessed 10 Oct. 2021).

### Example 2

The invention provides a novel plasma-based adsorption-conversion combined system that can capture and in situ convert CO₂ into CO at ambient temperature and pressure, with the adaptability to point-source and direct air capture applications. In this system, CO₂ will be captured via a structured sorbent/catalyst that will work as a conductive medium for the novel transferred DC arc plasma, leading to in-situ CO₂ conversion under ambient conditions. The system is modular, easily scalable by just numbering up, and easily adaptable to both post-combustion (PC) and direct air capture (DAC) applications cost-effectively.

The continuous rise of CO₂ emissions due to energy production and industrial activities contributes to the escalating issues of global warming. Carbon capture, utilization and storage (CCUS) is regarded as a vital component in the decarbonization portfolio. Solid sorbent materials-based CO₂ capture is gaining interest over the current state-of-the-art solvent-based capture process due to the drawbacks of the solvent-based process, including corrosivity, volatilization, susceptibility to oxidation, waste generation, and massive water requirements. However, the major drawback of sorbent-based adsorption technologies involves the energy-intensive temperature/pressure/vacuum swing regeneration steps. More crucially, CO₂ conversion typically necessitates different elevated temperature and pressure combinations due to the molecule's stability against forming another product. Thus, it remains a challenge to develop a simultaneous capture and conversion system that operates under ambient temperature and pressure for cost-effectiveness and safety. This proposal seeks to solve this problem by developing a novel carbon sorbent/catalyst-assisted plasma system that can provide a low-cost option for simultaneous CO₂ capture and conversion at ambient temperature and pressure, with the adaptability to both point-source and direct air capture applications.

Carbon Monoxide (CO) is an industrial intermediate to produce bulk organic chemicals such as ethanol, 2,3-butanediol, and methyl ethyl ketone. At present, all these bulk chemicals are produced from fossil-based feedstocks. The benefits of waste CO₂-derived CO utilization in producing these bulk chemicals are two-fold: 1) reduction in the dependence on fossil feedstocks, and 2) waste CO₂ valorization and net CO₂ emission reduction. In a recent study, Dielectric Barrier Discharge (DBD) plasma as an energy source in conjunction with a hydrotalcite catalyst packed-bed reactor was used for simultaneous CO₂ capture and CO production under ambient temperature, and pressure [1]. However, achieving higher energy efficiency is a major drawback of using plasma. The energy efficiency for CO₂ to CO conversion can be improved by coupling the Boudouard reaction (in the presence of solid carbon) with thermal arc plasma [2]. In this approach, the CO₂ is first cracked into CO, O₂, and O by plasma (endothermic process). Then, O₂ and O react with solid carbon to produce more CO (exothermic process). The resultant overall process not only increases the overall CO production but also reduces energy consumption utilizing the heat from exothermic reaction. The invention provides a novel “structured catalyst mediated transferred DC arc plasma reactor” system [3]. The reactor system was demonstrated for CO₂ to CO production with a CO₂ conversion of 40% through reverse water-gas shift reaction using Nickel (Ni) based catalysts. On the other hand, the invention provides high-surface area porous carbon materials [4-6]. These carbon materials can be made conductive, can serve as a CO₂ adsorbent, and also as a support for structured metal carbide catalysts for the novel transferred DC arc plasma reactor to convert CO₂ to CO efficiently, which has not been explored yet. More specifically, several scientific questions remain unanswered, including: 1) What properties of the carbon materials lead to the best adsorption and conversion performances in the transferred DC arc plasma system; 2) What is the most efficient pathway of CO formation? Is it CO₂ dissociation on the catalyst surface followed by the Boudouard reaction either on the catalyst metal carbide surface or on the carbon materials support, or CO₂ splitting by plasma first followed by the Boudouard reaction? Herein, the invention resolves the above-mentioned scientific queries and develops a novel plasma-based adsorption-conversion combined system (adsorbent/catalyst development, plasma reactor design, process optimization) that can capture and in situ convert CO₂ into CO economically, safely with a least carbon footprint as compared to other CO production processes.

### References for Example 3

[1] S. Li, M. Ongis, G. Manzolini, F. Gallucci. Chemical Engineering Journal, 2021, 410, 128335
[2] Z. Li, T. Yanga, S. Yuana, Y. Yina, E. J. Devid, Q. Huang, D. Auerbach, A. W. Kleyn. Journal of Energy Chemistry 45 (2020) 128-134.
[3] C. Baroi, 2023. Carbon Dioxide (CO₂) to value added products production (CO₂ utilization) near room temperature using ultra-low energy consuming plasma in presence of catalysts/structured catalysts. IDR #2023-144, University of Illinois Urbana-Champaign.
[4] Y. Yin, T. Yang, Z. Li, E. Devid, D. Auerbach, A. W. Kleyn. Phys. Chem. Chem. Phys. 2021, 23, 7974.
[5] J. He, J. W F To, P. C. Psarras, H. Yan, T. Atkinson, R. T. Holmes, D. Nordlund, Z. Bao, J. Wilcox. Advanced Energy Materials, 2016, 6 (14), 1502491.
[6] J. WF To, J. He, J. Mei, R. Haghpanah, Z. Chen, T. Kurosawa, S. Chen, W.-G. Bae, L. Pan, J. B-H Tok, J. Wilcox, Z Bao. Journal of the American Chemical Society, 2016, 138 (3), 1001-1009.

The invention provides a novel carbon sorbent/catalyst-assisted plasma system that can provide a low-cost option for simultaneous CO₂ capture and conversion at ambient temperature and pressure, with the adaptability to point-source and direct air capture applications.

In an embodiment, the invention deals with the synthesis of carbon based adsorbent materials. This allows the development of carbon materials with novel structures and properties.

In another embodiment, the invention deals with the tune-up of the plasma reactor system to maximize the plasma energy intensity both experimentally and also with the aid of the CFD simulation. This allows for the characterization of the properties of plasma.

In another embodiment, the invention deals with the CO₂ capture using carbon based adsorbent materials and regeneration under plasma condition. This allows for the correlation of the carbon materials structure/properties and plasma energy on the CO₂ capture efficiency.

In another embodiment, the invention deals with the decoration of the carbon based adsorbent materials with active components showing catalytic activities. This allows for synthesis of carbon supported metal/mixed metal or its carbide catalysts following different novel approaches.

In another embodiment, the invention deals with the evaluation of structured adsorbent/catalyst performance under plasma condition for CO production. This not only allows for screening the best dual functional materials, but also allows for seeking answers for several scientific questions, including: 1) What properties of the carbon materials lead to the best adsorption and conversion performances in the transferred DC arc plasma system; 2) What is the most efficient pathway of CO formation? Is it CO₂ dissociation on the catalyst surface followed by the Boudouard reaction either on the catalyst metal carbide surface or on the carbon materials support, or CO₂ splitting by plasma first followed by the Boudouard reaction?

In another embodiment, the invention deals with the techno-economic and life-cycle analysis. These analyses will allow evaluation of the economic feasibility and environmental footprint assessment of the technology.

### Market Impacts

The invention provides for the production of carbon monoxide (CO) from waste CO₂ as feedstock. CO is an intermediate for the large-scale industrial production of organic chemicals such as ethanol, 2,3-butanediol, and methyl ethyl ketone, with ethanol as the most impactful product. As per EIA, New York State consumed more than 500 million gallons of fuel ethanol in 2021. This consumption amount is projected to rise due to several drivers. First, the state policies and regulations favor the use of ethanol-blended fuel for environmental protection considerations. For example, in an effort to reduce ozone generation, the New York City metropolitan area and Long Island mandate the utilization of reformulated motor gasoline that blends with ethanol. Another example involves the recent commercialization of E15 in New York State, which is a low-cost, low-carbon fuel blend containing 15% ethanol. Second, ethanol is a crucial compound in the industrial production of various other products, such as adhesives, cosmetics, detergents, inks, hand creams, plastics, paints, textiles, vinegar, and others. New York State's GDP has a strong recovery from the pandemic (a 7.99% increase in 2022 from 2021). With the economic growth, the markets of the above-mentioned ethanol-derived products are expected to grow, and so is the market for ethanol.

However, compared to the high demand and consumption of ethanol, the state has only one ethanol production plant (Western New York Energy) with a capacity of 62 million gallons per year. The production amounts to only about 12% of the total consumption. The proposed technology will fill in the gap to support the ethanol demand and facilitate the growth of the ethanol market in New York State.

The market impacts of the invention are multifold. First, the invention requires a smaller footprint compared to conventional ethanol production, leading to a potentially reduced cost. With the scale of the current annual fuel ethanol production in New York (i.e., 62 million gallons), the land use for corn growing is estimated to be about 155,000 acres (as per USDA Farm Service Agency). In contrast, the invention has much less land use, as it takes atmospheric CO₂ as the starting material. Second, the invention can have a more reliable and predictable production compared to conventional corn-based ethanol production. Corn growth is largely affected by weather conditions and is susceptible to insect damage. Besides, it is also impacted by the cost of fertilizer and water. In contrast, the invention can eliminate these agricultural uncertainties and provide more reliable production. Third, the invention can complement the current ethanol production in New York and enhance the state's security of ethanol supply. Currently, only 12% of the total ethanol consumption in the state is produced locally, with the rest imported from the Midwest and overseas. The invention will enhance local production to keep up with the demand growth, without adding stress to land and water use, which helps ensure the uninterrupted availability of ethanol supply at an affordable price.

First, embodiments of the invention are directly linked to the first market impact pertaining to reduced land use and production cost. These embodiments provide for studying the scalability of the invention and the corresponding footprint of the production plant. The embodiments provide for using reaction and system modeling techniques, based on the optimized CO₂ capture and conversion performance in earlier activities. Second, embodiments of the invention include life-cycle analyses (LCA) to study and validate the material balance and energy balance of the novel system. This will address the second market impact regarding the reliability and predictability of the proposed technology. Third, embodiments of the inventions are also linked to the third market impact related to providing a complementary local supply of ethanol, as these activities will validate the scalability of the optimized system of the invention.

Certain embodiments are likely to result in the aforementioned market impacts, in that said embodiments cover a broad spectrum of new technology development, ranging from fundamental understanding, process optimization, model development, TEA, and LCA. There has been preliminary data on carbon sorbent materials and a proof-of-concept plasma-assisted CO₂ conversion system. In an embodiment, the invention includes advanced material characterization, adsorption testing, in-house plasma systems, and modeling software.

### Environmental Impacts

The net GHG of the invention has potential to be net-negative, since the invention captures CO₂ from air and converts it to CO. Assuming the required energy supply for the plasma will be renewable energy, in a broader prospective, the overall GHG emission will be net negative.

An embodiment of the invention focuses on only CO₂ capture and is assumed to consume lower energy. Thus, the expected GHG emission will be very low. Another embodiment of the invention will focus on CO₂ capture and conversion. Thus, the expected GHG emission will be negative, assuming the energy supply comes from a renewable energy source. Another embodiment of the invention focuses on a detailed LCA, which counts the emissions associated with the adsorbent/catalyst materials synthesis, construction of the reactor systems.

The invention provides if not net negative then very close to near-zero GHG emissions.

### Tech-to-Market Plan

The invention resolves some scientific queries (mentioned in the “Background” section) and develops a novel plasma-based adsorption-conversion combined system that can capture and in situ convert CO₂ into CO economically, safely with a least carbon footprint as compared to other CO production processes. The invention is modular, easily scalable by simply numbering up, and readily adaptable to both post-combustion (PC) and direct air capture (DAC) applications in a cost-effective fashion.

### Example 4

Capture and in-situ Conversion of CO₂ Using Novel Plasma Technology Under Ambient Conditions

### Overview & Motivation

The continuous rise of CO₂ emissions due to energy production and industrial activities contributes to the escalating issues of global warming. Carbon capture, utilization and storage (CCUS) is regarded as a vital component in the decarbonization portfolio. Solid sorbent materials-based CO₂ capture is gaining interest over the current state-of-the-art solvent-based capture process due to the drawbacks of the solvent-based process, including corrosivity, volatilization, susceptibility to oxidation, waste generation, and massive water requirements. However, the major drawback of sorbent-based adsorption technologies involves the energy-intensive temperature/pressure/vacuum swing regeneration steps. More crucially, CO₂ conversion typically necessitates different elevated temperature and pressure combinations due to the molecule's stability against forming another product. Thus, it remains a challenge to develop a simultaneous capture and conversion system that operates under ambient temperature and pressure for cost-effectiveness and safety. The invention seeks to solve this problem by providing a novel carbon sorbent/catalyst-assisted plasma system that can provide a low-cost option for simultaneous CO₂ capture and conversion at ambient temperature and pressure, with the adaptability to both point-source and direct air capture applications.

Carbon Monoxide (CO) is an industrial intermediate to produce bulk organic chemicals such as ethanol, 2,3-butanediol, and methyl ethyl ketone. At present, all these bulk chemicals are produced from fossil-based feedstocks. The benefits of waste CO2-derived CO utilization in producing these bulk chemicals are two-fold: 1) reduction in the dependence on fossil feedstocks, and 2) waste CO₂ valorization and net CO₂ emission reduction. In a recent study, Dielectric Barrier Discharge (DBD) plasma as an energy source in conjunction with a hydrotalcite catalyst packed-bed reactor was used for simultaneous CO₂ capture and CO production under ambient temperature, and pressure [1]. However, achieving higher energy efficiency is a major drawback of using plasma. The energy efficiency for CO₂ to CO conversion can be improved by coupling the Boudouard reaction (in the presence of solid carbon) with thermal arc plasma [2,3]. In this approach, the CO₂ is first cracked into CO, O₂, and O by plasma (endothermic process). Then, O₂ and O react with solid carbon to produce more CO (exothermic process). The resultant overall process not only increases the overall CO production but also reduces energy consumption utilizing the heat from exothermic reaction. The invention provides a novel “structured catalyst mediated transferred DC arc plasma reactor” system (FIGS. 2-3) [4]. The reactor system was demonstrated for CO₂ to CO production with a CO₂ conversion of 40% through reverse water-gas shift reaction using

Nickel (Ni) based catalysts. The invention provides high-surface area porous carbon materials [5-6]. These carbon materials can be made conductive, can serve as a CO2 adsorbent, and also as a support for structured metal carbide catalysts for the novel transferred DC arc plasma reactor to convert CO₂ to CO efficiently, which has not been explored yet. More specifically, several scientific questions remain unanswered, including: 1) What properties of the carbon materials lead to the best adsorption and conversion performances in the transferred DC arc plasma system; 2) What is the most efficient pathway (higher conversion using low plasma energy) of CO formation? Is it CO₂ dissociation on the catalyst surface followed by the Boudouard reaction either on the catalyst metal/metal carbide surface or on the carbon materials support, or CO₂ splitting by plasma first followed by the Boudouard reaction? Herein, the above-mentioned scientific queries will be resolved and a novel plasma-based adsorption-conversion combined system (adsorbent/catalyst development, plasma reactor design, process optimization) will be developed that can capture and in situ convert CO₂ into CO economically, safely with a lower carbon footprint as compared to other CO production processes. The proposed system is modular, easily scalable by simply numbering up, and readily adaptable to both post-combustion (PC) and direct air capture (DAC) applications in a cost-effective fashion.

### Goals and Objectives

The overall goal of the project is to create a novel carbon sorbent/catalyst-assisted plasma system that can provide a low-cost option for simultaneous CO₂ capture and conversion at ambient temperature and pressure, with the adaptability to point-source and direct air capture applications. To achieve this goal, the PIs will pursue the following sub-objectives throughout the proposed work: i) engineering the porous characteristics and chemical functionality of carbon materials for enhanced CO₂ adsorption and subsequent conversion under plasma conditions; ii) tuning the reactor dimension and plasma reaction conditions for optimized CO₂ conversion; and iii) evaluation of the cost and carbon footprint reduction potential through techno-economic and life-cycle analyses.

Performance testing of non-catalytic structured materials and plasma reactor. In an embodiment, the invention experimentally measures the sorption isotherms of CO₂ to evaluate the CO₂ adsorption behavior of the carbon materials developed. Based on these sorption isotherms, capture performance metrics such as capacity, CO₂/N₂ selectivity, and heat of adsorption are assessed. The best-performing sorbent material and structure is used for the plasma reactor configuration and design evaluation.

Air/gas intake and mixing modeling within the reactor (in absence of plasma). In an embodiment, the invention performs Computational Fluid Dynamics (CFD) modeling on the air/gas intake and mixing inside the plasma reactor in absence and presence of structured carbon-based materials with different micro/meso/macro porosity.

Modeling of CO₂ capture in presence of plasma. In an embodiment, a plasma chemistry and plasma transport model are developed based on data collected to complement and optimize both the structure of the carbon materials (macro-scale) and the plasma reactor dimensions to maximize the CO₂ capture utilizing the lowest plasma energy.

Evaluation of structured adsorbent/catalyst performance under plasma condition. In an embodiment, the performance of different catalyst-coated structured adsorbents for CO₂ to CO production under a fixed composition of flow of CO₂ & H₂ and CO₂ & CH₄ is evaluated. The catalyst elements and compositions are updated based on the performances.

Preliminary Techno-economic (TEA) and Life-cycle analysis (LCA). In an embodiment, a preliminary TEA and LCA are performed based on the adsorbent/catalyst performance under plasma conditions to set up the performance targets from the process optimization.

Optimization of the process conditions for capture and conversion. In an embodiment, the best-performing catalyst decorated structured carbonaceous material is exploited for the process optimization. The gas composition, gas flow rate, and plasma energy are varied to maximize the CO₂ uptake and conversion.

Updated air/gas intake and mixing modeling. In an embodiment, the Air/gas intake and mixing modeling within the reactor (in absence of plasma) is re-iterated considering the catalyst doped structured carbon materials.

Plasma transport and chemical kinetics modeling utilizing CFD. In an embodiment, plasma chemistry, plasma transport coupled with chemical kinetics model are developed to characterize and analyze which reaction pathways play a major role in CO₂ dissociation and CO production. The modeling results are compared against data collected.

Final TEA and LCA. In an embodiment, the final TEA and LCA are developed.

In an embodiment, the invention provides for the synthesis of at least 20 carbon materials and 20 catalyst-coated carbon materials.

In an embodiment, the invention provides for CO₂ adsorption capacity above 1.5 mmol/g at the conditions relevant to post-combustion capture.

In an embodiment, the invention provides for a CFD model performance supporting the air/gas intake and mixing (in absence of plasma).

In an embodiment, the invention provides CFD model performance supporting the plasma reactor design and dimension.

In an embodiment, the invention achieves at least 45% CO₂ conversion and provides for selection of the appropriate catalysts for maximum CO production.

In an embodiment, the invention provides for a target CO₂ conversion, CO yield, plasma energy efficiency through TEA and LCA.

In an embodiment, the invention provides: i) synthesis of at least 20 carbon-based materials capable of adsorbing at least 1.5 mmol/g CO₂, ii) optimization of plasma reactor design; iii) set-up performance target through TEA and LCA.

In an embodiment, the invention provides a Chemical kinetics model

In an embodiment, the invention identifies economic feasibility and environmental footprint through TEA and LCA.

In an embodiment, the invention provides a plasma-based reactor system for simultaneous CO₂ capture and conversion.

In an embodiment, the invention provides dual function (adsorbent and catalyst) structured materials and a plasma-based process utilizing these materials for converting CO₂ to CO efficiently.

### References for Example 4

[1] S. Li, M. Ongis, G. Manzolini, F. Gallucci, Non-thermal plasma-assisted capture and conversion of CO₂, Chemical Engineering Journal, 2021, 410, 128335
[2] Z. Li, T. Yanga, S. Yuana, Y. Yina, E. J. Devid, Q. Huang, D. Auerbach, A. W. Kleyn. Boudouard reaction driven by thermal plasma for efficient CO₂ conversion and energy storage. Journal of Energy Chemistry, 2020, 45, 128-134.
[3] Y. Yin, T. Yang, Z. Li, E. Devid, D. Auerbach, A. W. Kleyn, CO₂ conversion by a plasma: how to get efficient CO₂ conversion and high energy efficiency, Physical Chemistry Chemical Physics, 2021, 23, 7974.
[4] C. Baroi, 2023. Carbon Dioxide (CO₂) to value added products production (CO₂ utilization) near room temperature using ultra-low energy consuming plasma in presence of catalysts/structured catalysts. IDR #2023-144, University of Illinois Urbana-Champaign.
[5] J. He, J. WF To, P. C. Psarras, H. Yan, T. Atkinson, R. T. Holmes, D. Nordlund, Z. Bao, J. Wilcox. Tunable Polyaniline-Based Porous Carbon with Ultrahigh Surface Area for CO₂ Capture at Elevated Pressure, Advanced Energy Materials, 2016, 6 (14), 1502491.
[6] J. WF To, J. He, J. Mei, R. Haghpanah, Z. Chen, T. Kurosawa, S. Chen, W.-G. Bae, L. Pan, J. B-H Tok, J. Wilcox, Z Bao, Hierarchical N-Doped Carbon as CO₂ Adsorbent with High CO₂ Selectivity from Rationally Designed Polypyrrole Precursor, Journal of the American Chemical Society, 2016, 138 (3), 1001-1009.

### Example 5

### Capture and In-Situ Conversion of CO₂ Using Novel Plasma Technology Under Ambient Conditions

The invention provides a novel plasma-based adsorption-conversion combined system that can capture and in situ convert CO₂ into value-added products such as CO and/or C₂⁺. In this system, CO₂ is captured via a structured sorbent/catalyst that will work as a conductive medium for the novel transferred DC arc plasma, leading to in-situ CO₂ conversion under ambient conditions. The system is modular, easily scalable by just numbering up, and easily adaptable to both post-combustion (PC) and direct air capture (DAC) applications cost-effectively.

### Background & Motivation

Solid sorbent materials-based CO₂ capture is gaining interest due to the waste generation associated with the solution-based capture solvents and water consumption during those solvents regeneration. However, the major drawback of sorbent-based adsorption technologies involves the energy intensive temperature/pressure/vacuum swing regeneration steps. More crucially, CO₂ conversion typically necessitates different elevated temperature and pressure combinations due to the molecule's stability against forming another product. Thus, it remains a challenge to develop a simultaneous capture and conversion system that operates under similar conditions, preferably ambient temperature and pressure. In a recent study, Dielectric Barrier Discharge (DBD) plasma in conjunction with catalyst packed-bed reactor was used for simultaneous CO₂ capture and CO production [1]. The CO production yield and plasma energy efficiency can be enhanced by using solid carbon-based catalysts. In addition, DC arc plasma is more energy efficient as compared to that for the DBD plasma [2]. Hence, it is hypothesized that solid carbon-based structured catalysts in conjunction with the novel transferred DC arc plasma will be a win-win combination for efficient CO₂ capture and simultaneous CO and/or C₂⁺ production.

The invention provides for catalysis, reaction engineering, plasma, techno-economic and life-cycle analyses. In an embodiment, the invention provides a novel “structured catalyst mediated transferred DC arc plasma reactor” system (FIGS. 2-3). The invention provides demonstration of the reactor system for CO₂ to CO production with a CO₂ conversion of 43% through a reverse water-gas shift reaction. The invention provides enabling the optimization of the performance, further maturing the technology, and enabling the use of flue gas or ambient air as a CO₂ source directly. Furthermore, techno-economic and overall life-cycle analyses will be performed. The invention include use of adsorbent materials design and development for CO₂ capture. The invention provides high-surface area porous carbon materials [3-5].

### REFERENCES

[1] S. Li, M. Ongis, G. Manzolini, F. Gallucci, Non-thermal plasma-assisted capture and conversion of CO₂, Chemical Engineering Journal, 2021, 410, 128335
[2] Y. Yin, T. Yang, Z. Li, E. Devid, D. Auerbach, A. W. Kleyn, CO₂ conversion by a plasma: how to get efficient CO₂ conversion and high energy efficiency, Phys. Chem. Chem. Phys. 2021, 23, 7974.
[3] J. He, J. WF To, P. C. Psarras, H. Yan, T. Atkinson, R. T. Holmes, D. Nordlund, Z. Bao, J. Wilcox. Tunable Polyaniline-Based Porous Carbon with Ultrahigh Surface Area for CO₂ Capture at Elevated Pressure, Advanced Energy Materials, 2016, 6 (14), 1502491.
[4] J. WF To, J. He, J. Mei, R. Haghpanah, Z. Chen, T. Kurosawa, S. Chen, W.-G. Bae, L. Pan, J. B-H Tok, J. Wilcox, Z Bao, Hierarchical N-Doped Carbon as CO₂ Adsorbent with High CO₂ Selectivity from Rationally Designed Polypyrrole Precursor, Journal of the American Chemical Society, 2016, 138 (3), 1001-1009.
[5] S. Chen, H. Gong, B. Dindoruk, J. He, Z. Bao, Dense Carbon Nanoflower Pellets for Methane Storage, ACS Applied Nano Materials, 2020, 3 (8), 8278-8285.

It should be emphasized that the above-described embodiments of the present invention, particularly any “preferred” embodiments, are merely possible examples of implementations, merely set forth for a clear understanding of various principles of the invention. Many variations and modifications may be made to the above-described embodiments of the invention without departing substantially from the spirit and various principles of the invention. All such modifications and variations are intended to be included herein within the scope of this disclosure and the present invention and protected by the following claims.

In a first aspect, an apparatus is provided. The apparatus includes: a gas flow cell having an inlet and an outlet for flowing a gas through said gas flow cell; a structured material within said gas flow cell, wherein the structured material has an electrical conductivity selected from the range of 3×10⁻¹⁵ S/m to 6.3×10⁷ S/m; and a plasma source integrated with said gas flow cell, the plasma source being configured to generate a plasma within a portion of the gas flow cell, the plasma source comprising: a first electrode and a second electrode within said gas flow cell; and a power source configured to provide voltage to the first and second electrodes.

In a second aspect according to the first aspect, the structured material is a sorbent material.

In a third aspect according to the first or second aspect, the structured material is a catalyst.

In a fourth aspect according to the third aspect, the structured material is a photocatalyst.

In a fifth aspect according to the third or fourth aspect, the structured material is conductive, magnetic, thermoelectric, piezoelectric, ferroelectric, semi-conductive, or a combination of said properties.

In a sixth aspect according to any one of the previous aspects, the structured material comprises a material selected from the group consisting of: a metal foam, a ceramic, a silicon carbide, a metal carbide, a porous carbon, a carbon foam, a metallic alloy mesh, a porous single or mixed oxide, a porous composite, an engineered designed porous composite, a polyaniline-based porous carbon, a hierarchical n-doped carbon, a coated adsorbent, and a coated catalyst.

In a seventh aspect according to the sixth aspect, the structured material comprises a coated adsorbent or a coated catalyst, wherein the coated adsorbent or coated catalyst comprises a powdered precoating, wherein the powdered precoating comprises a layer comprising at least one thermoelectric and/or piezoelectric and/or ferroelectric material powder.

In an eighth aspect according to any one of the previous aspects, the structured comprises a coated adsorbent, a coated catalyst, or a coated photocatalyst, the coated adsorbent, coated catalyst, or coated photocatalyst comprises a metal or mixed metal; a single oxide; a single sulfide; a single nitride; a single carbide; a combination of oxides, sulfides, nitrides, or carbides; and the metal is selected from the group consisting of: Ni, Mo, Cu, Zn, Ce, Cd, La, Al, Fe, Ti, Sn, Li, Pr, Co, Mn, B, Bi, Nb, W, Te, Zr, Pb, V, Ca, and Mg.

In a ninth aspect according to any one of the previous aspects, the structured material is characterized by a porosity selected from the range of 2% to 98%.

In a tenth aspect according to any one of the previous aspects, the structured material is characterized by an average pore size selected from the range of 0.1 nm to 100 nm.

In an eleventh aspect according to any one of the previous aspects, the structured material is characterized by a surface area selected from the range of 5 m²/g to 3500 m²/g.

In a twelfth aspect according to any one of the previous aspects, the structured material is within the gas flow cell and is not in physical contact with the first electrode, the second electrode, or the gas flow cell.

In a thirteenth aspect according to any one of the first to eleventh aspects, the structured material comprises a coating or film on an internal surface of the gas flow cell.

In a fourteenth aspect according to any one of the previous aspects, the structured material is covered with a layer comprising at least one thermoelectric, and/or piezoelectric, and/or ferroelectric material powder.

In a fifteenth aspect according to any one of the previous aspects, the plasma source is integrated with the gas flow cell so as to generate said plasma that at least partially interacts with the gas and the structured material.

In a sixteenth aspect according to any one of the previous aspects, the plasma is an AC current plasma.

In a seventeenth aspect according to any one of the previous aspects, the plasma is a DC current plasma.

In an eighteenth aspect according to any one of the previous aspects, the plasma is an arc plasma.

In a nineteenth aspect according to any one of the previous aspects, the plasma is characterized by a temperature selected over the range of 293.15 K to 35273.15 K.

In a twentieth aspect according to any one of the previous aspects, the distance between the first electrode and the second electrode is selected from the range of 25 mm to 190 cm.

In a twenty-first aspect according to any one of the previous aspects, the distance between the first electrode and the structured material, and the distance between the second electrode and the structured material are each independently selected from the range of 0.5 mm to 90 cm.

In a twenty-second aspect according to any one of the previous aspects, the distance between the first electrode and the inlet, and the distance between the second electrode and the outlet are each independently selected from the range of 2 mm to 120 cm.

In a twenty-third aspect according to any one of the previous aspects, the apparatus is configured for carbon capture, said gas comprises CO₂, and the structured material is a sorbent material.

In a twenty-fourth aspect according to any one of the previous aspects, the apparatus is configured for CO₂ conversion, said gas comprises CO₂, and the structured material is a catalyst and/or a photocatalyst.

In a twenty-fifth aspect according to the twenty-third aspect, the gas further comprises H₂, Ar, N₂, or a combination thereof.

In a twenty-sixth aspect according to the twenty-fourth or twenty-fifth aspects, the CO₂ conversion generates CO, CH₄, CH₃OH, CH₃CH₂OH, an organic acid, a hydrocarbon, an aldehyde, formaldehyde, acetaldehyde, or a combination thereof.

In a twenty-seventh aspect according to any one of the previous aspects, the apparatus is configured for CH₄ conversion, said gas comprises CH₄, and the structured material is a catalyst and/or a photocatalyst.

In a twenty-eighth aspect according to the twenty-seventh aspect, the gas further comprises CO₂, Ar, N₂, or a combination thereof.

In a twenty-ninth aspect according to the twenty-seventh or twenty-eighth aspects, the CH₄ conversion generates CO, H₂, or a combination thereof.

In a thirtieth aspect according to any one of the previous aspects, the apparatus is configured for NH₃ conversion, said gas comprises NH₃, and the structured material is a catalyst and/or a photocatalyst.

In a thirty-first aspect according to the thirtieth aspect, the gas further comprises Ar, N₂, or a combination thereof.

In a thirty-second aspect according to the thirtieth or thirty-first aspects, the NH₃ conversion generates H₂, N₂, or a combination thereof.

In a thirty-third aspect according to any one of the previous aspects, the apparatus is configured for alkane (e.g., CH₄, C₂H₆, C₃H₈, C₄H₁₀) conversion, said gas comprises an alkane, and the structured material is a catalyst and/or a photocatalyst.

In a thirty-fourth aspect according to the thirty-third aspect, the gas further comprises O₂, CO₂, Ar, N₂, or a combination thereof.

In a thirty-fifth aspect according to the thirty-third or thirty-fourth aspects, the alkane conversion generates an alkene (e.g., C₂H₂, C₂H₄, C₃H₆, C₄H₈).

In a thirty-sixth aspect according to any one of the previous aspects, the gas comprises one or more gases selected from the group consisting of: CO₂, hydrogen gas, nitrogen gas, ammonia, oxygen, and methane gas.

In a thirty-seventh aspect according to any one of the previous aspects, a pressure within the gas flow cell is ambient pressure.

In a thirty-eighth aspect according to any one of the previous aspects, the inlet and outlet; and the electrodes are in parallel directions.

In a thirty-ninth aspect according to any one of the first to thirty-seventh aspects, the inlet and outlet; and the electrodes are in opposite directions.

In a fortieth aspect according to any one of the first to thirty-seventh aspects, the inlet and outlet; and the electrodes are in perpendicular directions.

In a forty-first aspect according to any one of the previous aspects, the apparatus further comprises a resistive/joule heating source in thermal communication with the structured material, and said heating source is configured to pre-treat the structured material and/or to provide additional heating.

In a forty-second aspect a method of releasing or converting a gas is provided. The method includes: flowing the gas through a gas flow cell having an inlet, and outlet, and a structured material provided within said gas flow cell, wherein the structured material has an electrical conductivity selected from the range of 3×10⁻¹⁵ S/m to 6.3×10⁷ S/m; and generating a plasma with a portion of the gas flow cell, wherein the plasma at least partially interacts with the gas and the structured material, thereby causing release of the gas and/or conversion of the gas.

In a forty-third aspect according to the forty-second aspect, the method is for carbon capture, said gas comprises CO₂, and the structured material is an absorption/desorption material.

In a forty-fourth aspect according to any one of the forty-first to forty-third aspects, the method is for CO₂ conversion, said gas comprises CO₂, the structured material is a catalyst and/or a photocatalyst, and the CO₂ conversion generates CO, CH₄, CH₃OH, CH₃CH₂OH, an organic acid, a hydrocarbon, an aldehyde, formaldehyde, acetaldehyde, or a combination thereof.

In a forty-fifth aspect according to the forty-fourth aspect, the gas further comprises H₂, Ar, N₂, or a combination thereof.

In a forty-sixth aspect according to any one of the forty-first to forty-fifth aspects, the method is for CH₄ conversion, said gas comprises CH₄, the structured material is a catalyst and/or a photocatalyst, and the CH₄ conversion generates CO and H₂.

In a forty-seventh aspect according to the forty-sixth aspect, the gas further comprises CO₂, Ar, N₂, or a combination thereof.

In a forty-eighth aspect according to any one of the forty-first to forty-seventh aspects, the method is for NH₃ conversion, said gas comprises NH₃, the structured material is a catalyst and/or a photocatalyst, and the NH₃ conversion generates H₂, N₂, or a combination thereof.

In a forty-ninth aspect according to the forty-eighth aspect, the gas further comprises Ar, N₂, or a combination thereof.

In a fiftieth aspect according to any one of the forty-first to forty-ninth aspects, the method is for alkane (e.g., CH₄, C₂H₆, C₅H₈, C₄H₁₀) conversion, said gas comprises an alkane, and the alkane conversion generates an alkene (e.g., C₂H₂, C₂H₄, C₃H₆, C₄H₈).

In a fifty-first aspect according to the fiftieth aspect, the gas further comprises O₂, CO₂, Ar, N₂, or a combination thereof.

In a fifty-second aspect according to any one of the previous aspects, a flow rate of the gas may be at least 0.1 sccm, at least 0.5 sccm, at least 1 sccm, at least 5 sccm, at least 10 sccm, at least 15 sccm, or at least 20 sccm.

In a fifty-third aspect according to any one of the previous aspects, a flow rate of the gas may be at most 20 sccm, at most 15 sccm, at most 10 sccm, at most 5 sccm, at most 1 sccm, at most 0.5 sccm, or at most 0.1 sccm.

In a fifty-fourth aspect according to any one of the previous aspects, a flow rate of the gas may be selected from the range of 10 sccm to 20 sccm.

In a fifty-fifth aspect according to any one of the previous aspects, the pressure of the flow cell may be 1 atm.

In a fifty-sixth aspect according to any one of the previous aspects, the distance between the electrodes may be at least 0.5 in, at least 1 in, at least 1.5 in, at least 2 in, at least 2.5 in, at least 3 in, at least 3.5 in, at least 4 in, at least 4.5 in, at least 5 in, at least 5.5 in, or at least 6 in.

In a fifty-seventh aspect according to any one of the previous aspects, the distance between the electrodes may be at most 6 in, at most 5.5 in, at most 5 in, at most 4.5 in, at most 4 in, at most 3.5 in, at most 3 in, at most 2.5 in, at most 2 in, at most 1.5 in, at most 1 in, or at most 0.5 in.

In a fifty-eighth aspect according to any one of the previous aspects, the distance between the electrodes may be selected from the range of 4 in to 6 in.

In a fifty-ninth aspect, an apparatus is provided. The apparatus includes: a gas flow cell having an inlet and an outlet for flowing a gas through said gas flow cell; a structured material within said gas flow cell; and a plasma source integrated with said gas flow cell, the plasma source being configured to generate a plasma within a portion of the gas flow cell, the plasma source comprising: a first electrode within said gas flow cell; and a power source configured to provide voltage to the first electrode and the structured material.

In a sixtieth aspect according to the fifty-ninth aspect, the first electrode comprises a copper wire bunch.

In a sixty-first aspect according to the sixtieth aspect, the copper wire bunch comprises a plurality of copper wires.

In a sixty-second aspect according to the sixty-first aspect, each of the copper wires in the plurality of copper wires independently comprises a thickness of at least 0.25 mm, at least 0.5 mm, at least 0.75 mm, or at least 1 mm.

In a sixty-third aspect according to any of the previous aspects, each of the copper wires in the plurality of copper wires independently comprises a thickness of at most 1 mm, at most 0.75 mm, at most 0.5 mm, or at most 0.25 mm.

In a sixty-fourth aspect according to any of the previous aspects, each of the) copper wires in the plurality of copper wires independently comprises a thickness selected from the range of 0.5 mm to 1 mm.

In a sixty-fifth aspect according to the sixty-first aspect, the plurality of copper wires may comprise at least 5, at least 10, at least 15, at least 20, at least 25, or at least 30 copper wires.

In a sixty-sixth aspect according to any of the previous aspects, the plurality of copper wires may comprise at most 30, at most 25, at most 20, at most 15, at most 10, or at most 5 copper wires.

In a sixty-seventh aspect according to any of the previous aspects, the plurality of copper wires comprises a number of copper wires selected from the range of 10 to 30 copper wires.

In a sixty-eighth aspect according to any of the previous aspects, the apparatus may further comprise a resistive/joule heating source.

In a sixty-ninth aspect according to the sixty-eighth aspect, the resistive/joule heating source may be in thermal communication with the structured material.

In a seventieth aspect according any of the previous aspects, the resistive/joule heating source may be configured to pre-treat the structured material.

In a seventy-first aspect according to any of the previous aspects, the resistive/joule heating source may be in electrical communication with the structured material.

In a seventy-second aspect, according to the fifty-ninth aspect, the first electrode may comprise a copper wire or a copper rod.

In a seventy-third aspect according to the seventy-second aspect, the resistive/joule heating source may be in thermal communication with the structured material.

In a seventy-fourth aspect according any of the previous aspects, the resistive/joule heating source may be configured to pre-treat the structured material.

In a seventy-fifth aspect according to any of the previous aspects, the resistive/joule heating source may be in electrical communication with the structured material.

In a seventy-sixth aspect, an apparatus is provided. The apparatus includes: a gas flow cell having an inlet and an outlet for flowing a gas through said flow cell; a structured material within said gas flow cell; and a plasma source integrated with said gas flow cell, the plasma source being configured to generate a first plasma, a second plasma, a third plasma, a fourth plasma, and a fifth plasma within a portion of the gas flow cell, the plasma source comprising: a first electrode, a second electrode, a third electrode, a fourth electrode, and a fifth electrode within said gas flow cell; and a power source configured to provide voltage to the first, second, third, fourth, and fifth electrodes.

In a seventy-seventh aspect according to the seventy-sixth aspect, each of the first, second, third, fourth, and fifth electrodes comprise a copper wire or a copper rod.

In a seventy-eighth aspect according to any of the previous aspects, the first, second, and third electrodes are located on a distal side of the gas flow cell.

In a seventy-ninth aspect according to any of the previous aspects, the fourth and fifth electrodes are located on a proximal side of the gas flow cell.

In an eightieth aspect according to any of the previous aspects, the apparatus may further comprise 1, 2, 3, 4, 5, 6, 7, 8, 9, 10, 15, 20, 25, 30, 35, 40, 45, 50, 100, or more additional electrodes on the distal side of the gas flow cell between the first and third electrodes.

In an eighty-first aspect according to any of the previous aspects, the apparatus may further comprise 1, 2, 3, 4, 5, 6, 7, 8, 9, 10, 15, 20, 25, 30, 35, 40, 45, 50, 100, or more additional electrodes on the proximal side of the gas flow cell between the fourth and fifth electrodes.

In an eighty-second aspect according to any of the previous aspects, each of the additional electrode is configured to generate an additional plasma.

In an eighty-third aspect according to any of the previous aspects, each of the electrodes on the distal side of the gas flow cell are in electric communication with a first side of the power source.

In an eighty-fourth aspect according to any of the previous aspects, each of the electrodes on the proximal side of the gas flow cell are in electric communication with a second side of the power source.

In an eighty-fifth aspect according to any of the previous aspects, each additional electrode increases the efficiency of gas release and gas conversion.

In an eighty-sixth aspect according to any of the previous aspects, each electrode located on the distal side of the gas flow cell is not directly across the gas flow cell from an electrode located on the proximal side of the gas flow cell.

In an eighty-seventh aspect according to the seventy-sixth aspect, the apparatus further comprises a sixth electrode.

In an eighty-eighth aspect according to any of the previous aspects, the apparatus may further comprise 1, 2, 3, 4, 5, 6, 7, 8, 9, 10, 15, 20, 25, 30, 35, 40, 45, 50, 100, or more additional electrodes on the distal side of the gas flow cell between the first and third electrodes.

In an eighty-ninth aspect according to any of the previous aspects, the apparatus may further comprise 1, 2, 3, 4, 5, 6, 7, 8, 9, 10, 15, 20, 25, 30, 35, 40, 45, 50, 100, or more additional electrodes on the proximal side of the gas flow cell between the fourth and sixth electrodes.

In a ninetieth aspect according to any of the previous aspects, each additional electrode is configured to generate an additional plasma.

In a ninety-first aspect according to any of the previous aspects, each electrode located on the distal side of the gas flow cell is in electric communication with a first side of a power source.

In a ninety-second aspect according to any of the previous aspects, each electrode located on the proximal side of the gas flow cell is in electric communication with a second side of the power source.

In a ninety-third aspect according to any of the previous aspects, each electrode located on the distal side of the gas flow cell is directly across the gas flow cell from an electrode located on the proximal side of the gas flow cell.

In a ninety-seventh aspect according to the seventy-sixth aspect, the voltage is at least 1 V, at least 1.5 V, at least 2 V, at least 2.5 V, at least 3 V, at least 3.5 V, at least 4 V, at least 4.5 V, at least 5 V, at least 5.5 V, at least 6 V, at least 6.5 V, at least 7 V, at least 7.5 V, at least 8 V, at least 8.5 V, at least 9 V, at least 9.5 V, at least 10 V, at least 10.5 V, at least 11 V, at least 11.5 V, or at least 12 V.

In a ninety-eighth aspect according to any of the previous aspects, the voltage is at most 12 V, at most 11.5 V, at most 11 V, at most 10.5 V, at most 10 V, at most 9.5 V, at most 9 V, at most 8.5 V, at most 8 V, at most 7.5 V, at most 7 V, at most 6.5 V, at most 6 V, at most 5.5 V, at most 5 V, at most 4.5 V, at most 4 V, at most 3.5 V, at most 3 V, at most 2.5 V, at most 2 V, at most 1.5 V, or at most 1 V.

In a ninety-ninth aspect according to any of the previous aspects, the voltage is selected from the range of 1.5 V to 12 V.

In a hundredth aspect according to any of the previous aspects, the current provided by the power source to the electrodes is at least 0.1 A, 0.2 A, 0.3 A, 0.4 A, 0.5A, 1 A, 1.5 A, 2 A, 2.5 A, 3 A, 3.5 A, or 4 A.

In a hundred first aspect according to any of the previous aspects, the current provided by the power source to the electrodes is at most 4 A, 3.5 A, 3 A, 2.5 A, 2 A, 1.5

A, 1 A, 0.5 A, 0.4 A, 0.3 A, 0.2 A, or 0.1 A.

In a hundred second aspect according to any of the previous aspects, the current provided by the power source is selected from the range of 0.1 A to 4 A.

In a hundred third aspect according to the seventy-sixth aspect, the apparatus further comprises a resistive/joule heating source.

In a hundred fourth aspect according to any of the previous aspects, the resistive/joule heating source is in thermal communication with the structured material.

In a hundred fifth aspect according to any of the previous aspects, the resistive/joule heating source is configured to pre-treat the structured material.

### Statements Regarding Incorporation By Reference And Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An apparatus, the apparatus comprising:
a gas flow cell having an inlet and an outlet for flowing a gas through said gas flow cell;
a structured material within said gas flow cell, wherein the structured material has an electrical conductivity selected from the range of 3×10⁻¹⁵ S/m to 6.3×10⁷ S/m; and
a plasma source integrated with said gas flow cell, the plasma source being configured to generate a plasma within a portion of the gas flow cell, the plasma source comprising:
a first electrode and a second electrode within said gas flow cell; and
a power source configured to provide voltage to the first and second electrodes.

2. The apparatus of claim 1, wherein the structured material is a sorbent material, a catalyst, a photocatalyst, or a combination thereof.

3-4. (canceled)

5. The apparatus of claim 2, wherein the structured material is conductive, magnetic, thermoelectric, piezoelectric, ferroelectric, semi-conductive, or a combination of said properties.

6. The apparatus of claim 1, wherein the structured material comprises a material selected from the group consisting of: a metal foam, a ceramic, a silicon carbide, a metal carbide, a porous carbon, a carbon foam, a metallic alloy mesh, a porous single or mixed oxide, a porous composite, an engineered designed porous composite, a polyaniline-based porous carbon, a hierarchical n-doped carbon, a coated adsorbent, and a coated catalyst.

7. The apparatus of claim 6, wherein the structured material comprises a coated adsorbent or a coated catalyst, wherein the coated adsorbent or coated catalyst comprises a powdered precoating, wherein the powdered precoating comprises a layer comprising at least one thermoelectric and/or piezoelectric and/or ferroelectric material powder.

8. The apparatus of claim 1;
wherein the structured material comprises a coated adsorbent, a coated catalyst, or a coated photocatalyst;
wherein the coated adsorbent, coated catalyst, or coated photocatalyst comprises a metal or mixed metal; a single oxide; a single sulfide; a single nitride; a single carbide; a combination of oxides, sulfides, nitrides, or carbides; and
wherein the metal is selected from the group consisting of: Ni, Mo, Cu, Zn, Ce, Cd, La, Al, Fe, Ti, Sn, Li, Pr, Co, Mn, B, Bi, Nb, W, Te, Zr, Pb, V, Ca, and Mg.

9. The apparatus of claim 1, wherein the structured material is characterized by a porosity selected from the range of 2% to 98%.

10. The apparatus of claim 1, wherein the structured material is characterized by an average pore size selected from the range of 0.1 nm to 100 nm.

11. The apparatus of claim 1, wherein the structured material is characterized by a surface area selected from the range of 5 m²/g to 3500 m²/g.

12. The apparatus of claim 1, wherein the structured material is within the gas flow cell and is not in physical contact with the first electrode, the second electrode, or the gas flow cell.

13. The apparatus of claim 1, wherein the structured material comprises a coating or film on an internal surface of the gas flow cell.

14. The apparatus of claim 1, wherein the structured material is covered with a layer, wherein the layer comprises at least one thermoelectric, and/or piezoelectric, and/or ferroelectric material powder.

15. The apparatus of claim 1, wherein the plasma source is integrated with the gas flow cell so as to generate said plasma that at least partially interacts with the gas and the structured material.

16. The apparatus of claim 1, wherein the plasma is an AC current plasma, a DC current plasma, an arc plasma, or a combination thereof.

17-18. (canceled)

19. The apparatus of claim 1, wherein the plasma is characterized by a temperature selected over the range of 293.15 K to 35273.15 K.

20. The apparatus of claim 1, wherein the distance between the first electrode and the second electrode is selected from the range of 25 mm to 190 cm.

21. The apparatus of claim 1, wherein the distance between the first electrode and the structured material, and the distance between the second electrode and the structured material are each independently selected from the range of 0.5 mm to 90 cm.

22-41. (canceled)

42. A method of releasing or converting a gas, the method comprising:
flowing the gas through a gas flow cell having an inlet, an outlet, and a structured material provided within said gas flow cell, wherein the structured material has an electrical conductivity selected from the range of 3×10⁻¹⁵ S/m to 6.3×10⁷ S/m; and
generating a plasma within a portion of the gas flow cell, wherein the plasma at least partially interacts with the gas and the structured material, thereby causing release of the gas and/or conversion of the gas.

43. The method of claim 42, wherein the method is for carbon capture, wherein said gas comprises CO₂, and wherein the structured material is an absorption/desorption material.

44. The method of 42, wherein the method is for CO₂ conversion, wherein said gas comprises CO₂, wherein the structured material is a catalyst and/or a photocatalyst, wherein the CO₂ conversion generates CO, CH₄, CH₃OH, an organic acid, a hydrocarbon, or a combination thereof.

45-51. (canceled)
